(19) United States
(12) Patent Application Publication
(10) Pub. No.: US 2024/0353660 A1
(43) Pub. Date: Oct. 24, 2024

(54) OPTICAL SYSTEM, AND OPTICAL MODULE AND CAMERA MODULE COMPRISING SAME

(71) Applicant: LG INNOTEK CO., LTD., Seoul (KR)

(72) Inventors: Ji Sung KIM, Seoul (KR); Jung Goo JI, Seoul (KR)

(21) Appl. No.: 18/291,063

(22) PCT Filed: Jul. 20, 2022
(86) PCT No.: PCT/KR2022/010653

§ 371 Date: Jan. 22, 2024

(30) Foreign Application Priority Data
Jul. 20, 2021 (KR) 10-2021-0095145

(51) Int. Cl. G02B 15/14; G02B 13/00; G02B 15/28

(52) U.S. Cl. CPC G02B 15/143105; G02B 13/0045; G02B 13/009; G02B 15/28

(57) ABSTRACT

The optical system according to the embodiment includes a first lens group, a second lens group, and a third lens group sequentially arranged along an optical axis from an object side to an image side and wherein each of the first to third lens groups including at least one lens; wherein a refractive power sign of the first lens group and a refractive power sign of the second lens group are opposite to each other, and wherein the first lens group, the second lens group, and the third lens group satisfy Equation 1 below.

$$0.6 < \vert f\_ 1 / f\_ 23 \vert < 1.4 \qquad [ Equation 1 ]$$

(In Equation 1, f_1 is a focal length of the first lens group, f_23 is a combined focal length of the second lens group and the third lens group.)

### TECHNICAL FIELD

The embodiment relates to an optical system and an optical module and camera module including the same.

### BACKGROUND ART

Camera modules perform the function of photographing objects and saving them as images or videos, and are installed in various applications. In particular, the camera module is manufactured in an ultra-small size and is applied to not only portable devices such as smart phones, tablet PCs, and laptops, but also drones and vehicles, providing various functions.

For example, the optical system and optical module of the camera module may include an imaging lens that forms an image and an image sensor that converts the formed image into an electrical signal. At this time, the camera module may perform an autofocus (AF) function that automatically adjusts the distance between the image sensor and the imaging lens to align the focal length of the lens, and may perform a zooming function of zoom up or zoom out by increasing or decreasing the magnification of a distant object through a zoom lens.

In addition, the camera module adopts image stabilization (IS) technology to correct or prevent image shake caused by camera movement due to unstable fixation devices or user movement.

The most important element for this camera module to obtain an image is the imaging lens that forms the image. Recently, interest in high performance such as high image quality and high resolution has been increasing, and research is being conducted on optical systems that include multiple lenses to realize this. For example, research using a plurality of imaging lenses with positive (+) or negative (−) refractive power is being conducted to implement a high-performance optical system. However, when a plurality of lenses are included, the length of the entire optical system may increase, and there is a problem in that it is difficult to derive excellent optical and aberration characteristics.

On the other hand, when the optical system and optical module include a plurality of lenses, zoom and autofocus (AF) functions, etc. may be performed by controlling the position of one of the plurality of lenses or by controlling the position of a lens group including two or more lenses. However, when the lens or the lens group is to perform the function, the amount of movement of the lens or the lens group may increase exponentially. Accordingly, a device including the optical system and optical module may require a lot of energy, and there is a problem that a design that takes the amount of movement into consideration is required.

Additionally, when the optical system and optical module include a plurality of lenses, the overall length and height of the optical system and optical module may increase depending on the thickness, spacing, and size of the plurality of lenses. Accordingly, the overall thickness and size of devices such as smart phones and mobile devices including the optical system and optical module may increase, and it is difficult to provide them in smaller sizes.

Therefore, a new optical system and optical module that can solve the above-mentioned problems are required.

### DISCLOSURE

### Technical Problem

The embodiment provides an optical system with improved optical characteristics, and an optical module and camera module including the same.

Additionally, the embodiment provides an optical system capable of providing an autofocus (AF) function for subjects located at various distances, and an optical module and camera module including the same.

Additionally, the embodiment provides an optical system that may be implemented in a small and compact manner, as well as an optical module and a camera module including the same.

Additionally, the embodiment provides an optical system applicable to a folded camera having a thin thickness, and an optical module and a camera module including the same.

### Technical Solution

The optical system according to the embodiment comprises a first lens group, a second lens group, and a third lens group sequentially arranged along an optical axis from an object side to an image side and wherein each of the first to third lens groups including at least one lens; wherein a refractive power sign of the first lens group and a refractive power sign of the second lens group are opposite to each other, and wherein the first lens group, the second lens group, and the third lens group satisfy Equation 1 below.

$$0.6 < \vert f\_ 1 / f\_ 23 \vert < 1.4 \qquad [ Equation 1 ]$$

(In Equation 1, f_1 is a focal length of the first lens group, f_23 is a combined focal length of the second lens group and the third lens group.)

### Advantageous Effects

The optical system, optical module, and camera module according to the embodiment may have improved optical characteristics. In detail, the effective focal length (EFL) may be controlled by moving at least one lens group among a plurality of lens groups, and the moving distance of the moving lens group may be minimized. Accordingly, the amount of curvature that occurs depending on the moving distance of the moving lens group may be minimized, thereby minimizing the deterioration of image quality in the peripheral area.

Additionally, the embodiment may minimize the power consumption required when moving the lens group by minimizing the moving distance of the moving lens group.

Additionally, the embodiment may provide an autofocus (AF) function for subjects located at various distances using an optical system with a set shape, focal length, spacing, etc. In detail, the embodiment may provide an autofocus (AF) function for a subject located at infinity or a short distance using a single camera module.

Additionally, the embodiment may have a constant TTL value regardless of the distance to the subject in the range of infinity to short-distance. Accordingly, the optical system and the camera module including it can be provided in a slimmer structure.

Additionally, the optical system and camera module according to the embodiment may include at least one lens having a non-circular shape. Accordingly, the optical system has improved optical performance and can be implemented in a small size, so it can be provided more compactly than an optical system consisting of only a circular shape.

Additionally, the optical system and camera module according to the embodiment may include an optical path change member. Accordingly, the optical system can be applied to a folded camera that can have a thinner thickness, and a device including the camera can be manufactured with a thinner thickness.

### DESCRIPTION OF DRAWINGS

FIG. 1 is a configuration diagram of an optical system according to a first embodiment operating in the first mode.

FIG. 2 is a diagram for explaining the total track length (TTL) and back focal length (BFL) of the optical system according to the first embodiment operating in the first mode.

FIG. 3 is a configuration diagram of an optical system according to the first embodiment operating in the second mode.

FIG. 4 is a diagram for explaining the total track length (TTL) and back focal length (BFL) of the optical system according to the first embodiment operating in the second mode.

FIG. 5 is a diagram for explaining a lens of a non-circular shape.

FIG. 6 is a graph of the aberration diagram when the optical system according to the first embodiment operates in the first mode.

FIG. 7 is a graph of the aberration diagram when the optical system according to the first embodiment operates in the second mode.

FIG. 8 is a configuration diagram of an optical system according to a second embodiment operating in the first mode.

FIG. 9 is a configuration diagram of an optical system according to the second embodiment operates in the second mode.

FIG. 10 is a graph of the aberration diagram when the optical system according to the second embodiment operates in the first mode.

FIG. 11 is a graph of the aberration diagram when the optical system according to the second embodiment operates in the second mode.

FIG. 12 is a diagram showing a camera module according to an embodiment applied to a mobile device.

### MODE FOR INVENTION

Hereinafter, preferred embodiments of the present invention will be described in detail with reference to the attached drawings.

However, the technical idea of the present invention is not limited to some of the described embodiments, but may be implemented in various different forms, and as long as it is within the scope of the technical idea of the present invention, one or more of the components may be selectively combined or replaced between embodiments. In addition, terms (including technical and scientific terms) used in embodiments of the present invention, unless explicitly specifically defined and described, It can be interpreted as a meaning that can be generally understood by a person with ordinary knowledge in the technical field to which the present invention belongs, and the meaning of commonly used terms, such as terms defined in a dictionary, can be interpreted by considering the contextual meaning of the related technology. Additionally, the terms used in the embodiments of the present invention are for describing embodiments and are not intended to limit the present invention. In this specification, singular forms may also include plural forms unless specifically stated in the phrase, when described as “at least one (or more than one) of A, B, and C,” it may include one or more of all combinations that can be combined with A, B, and C.

Additionally, when describing the components of an embodiment of the present invention, terms such as first, second, A, B, (a), and (b) may be used. These terms are only used to distinguish the component from other components, and are not limited to the essence, sequence, or order of the component. And, when a component is described as being ‘connected’, ‘coupled’ or ‘connected’ to another component, the component is not only directly connected, combined, or connected to the other component, buy it also include cases where the component is ‘connected’, ‘coupled’, or ‘connected’ by another component between that component and that other component.

Additionally, when described as being formed or disposed “above” or “below” each component, “above” or “below” refers not only to instances where the two components are in direct contact with each other, but also includes cases where one or more other components are formed or disposed between two components. Additionally, when expressed as “up (above) or down (down),” it can include not only the upward direction but also the downward direction based on one component.

In the following description, the first lens refers to the lens closest to the object side, and the last lens refers to the lens closest to the image side. Additionally, unless otherwise specified, the units for lens radius, clear aperture, thickness, distance, BFL (Back Focal Length), and TTL (Total track length or Total Top Length) are all mm. Additionally, the shape of the lens is expressed based on the optical axis of the lens. For example, saying that the object side of the lens is convex means that the area around the optical axis on the object side of the lens is convex, and does not mean that the area around the optical axis is convex. Therefore, even if the object side of the lens is described as convex, the portion around the optical axis on the object side of the lens may be concave. Additionally, it should be noted that the thickness and radius of curvature of the lens are measured based on the optical axis of the lens. Additionally, “object side” may refer to the side of the lens facing the object side based on the optical axis, and “image side” may be defined as the side of the lens facing the imaging surface based on the optical axis.

Hereinafter, an optical system according to an embodiment will be described with reference to the drawings.

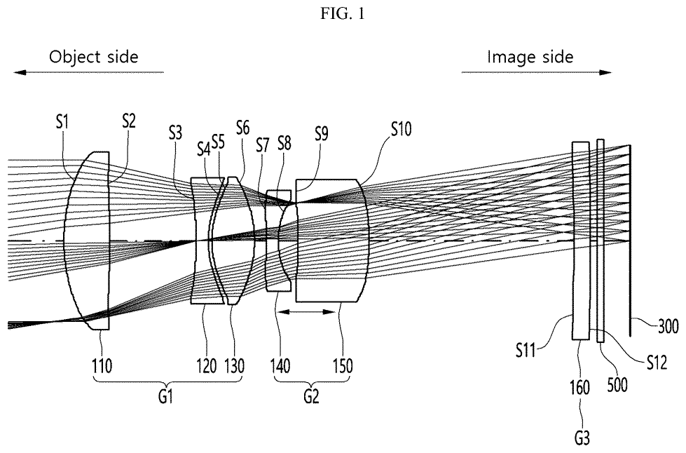

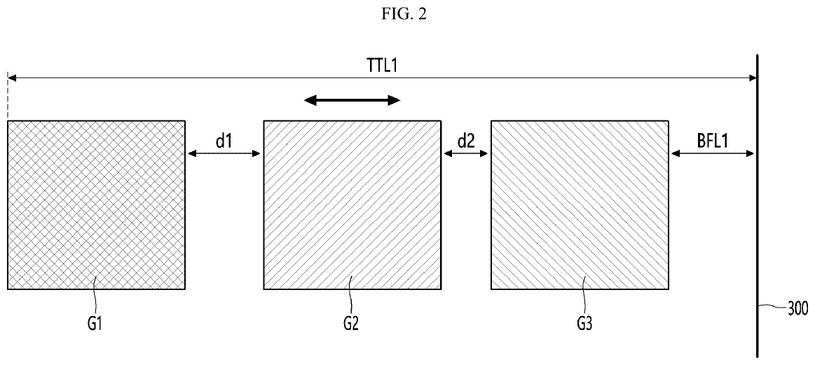

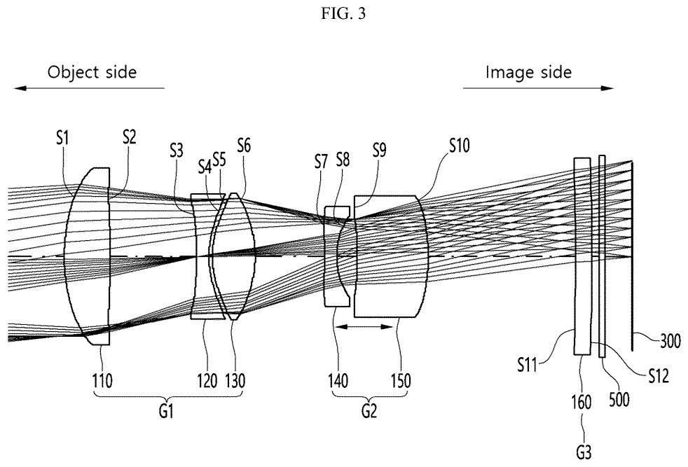

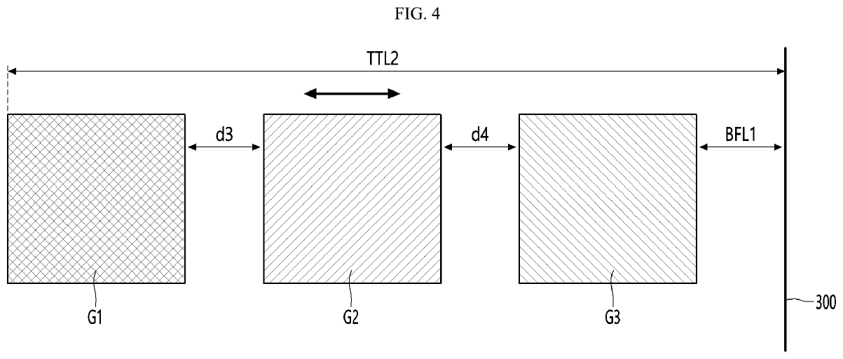

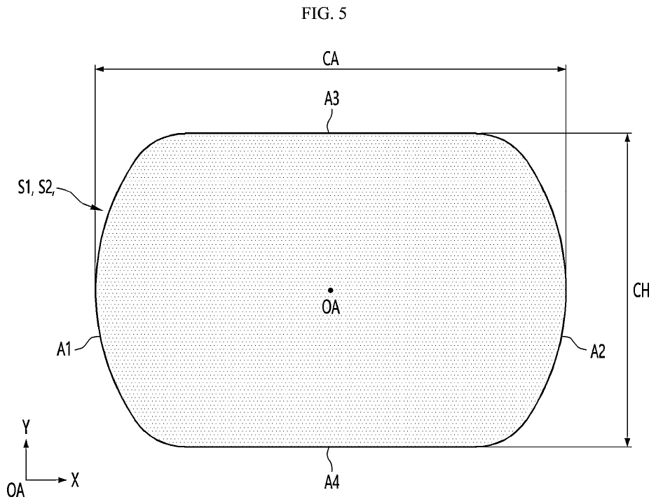

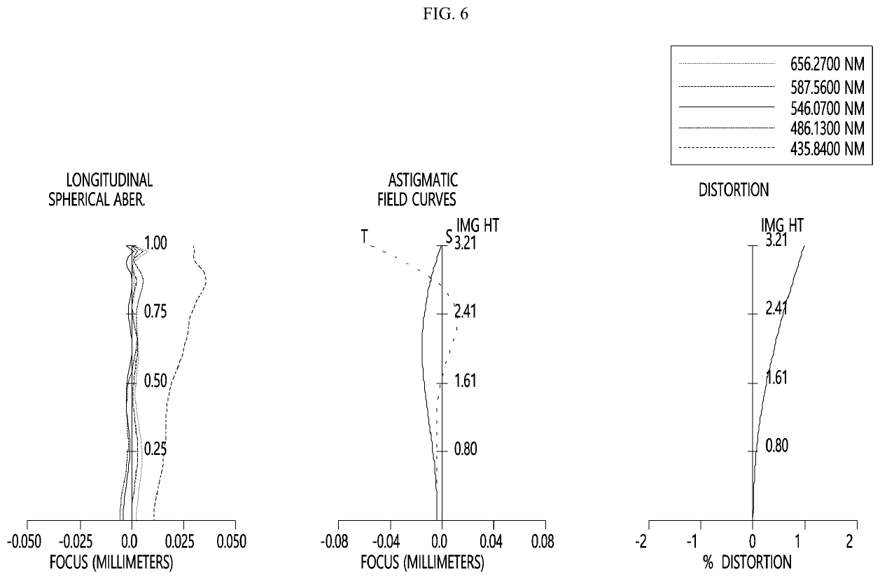

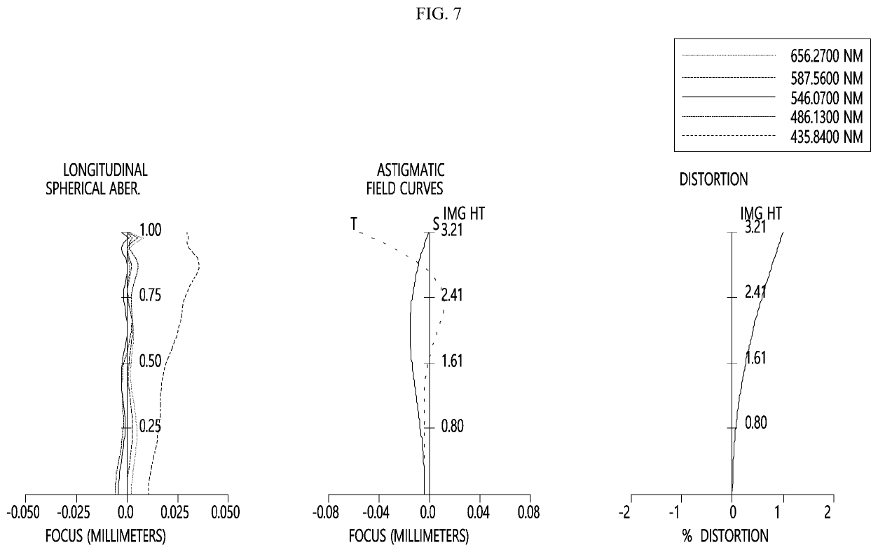

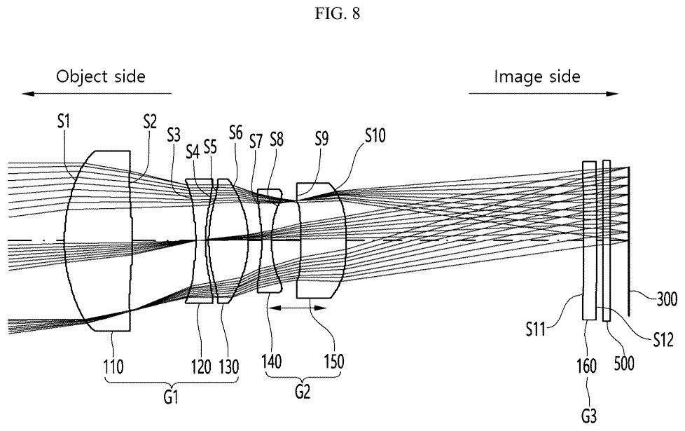

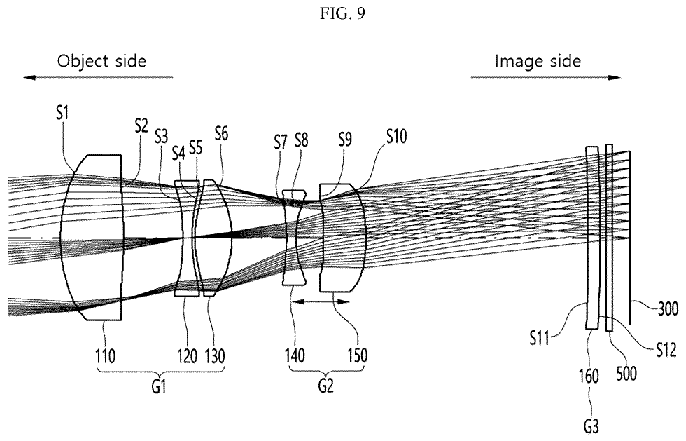

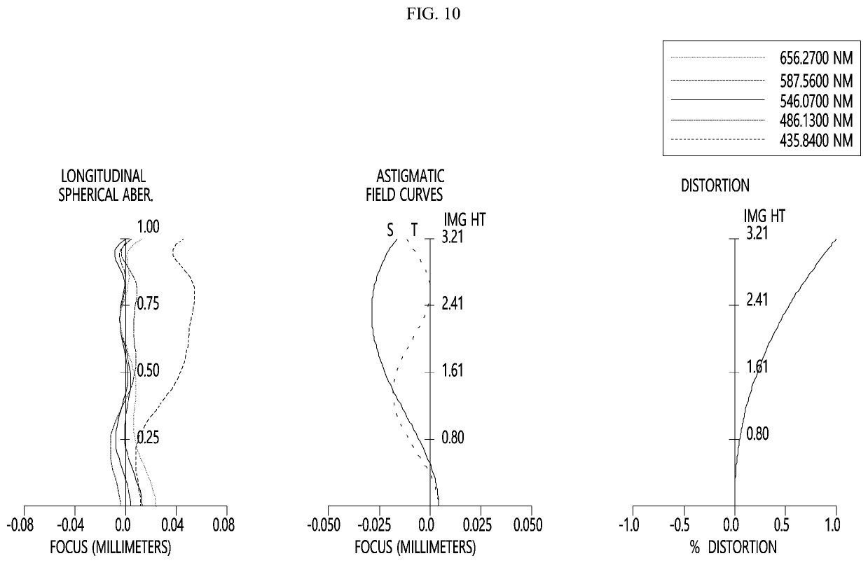

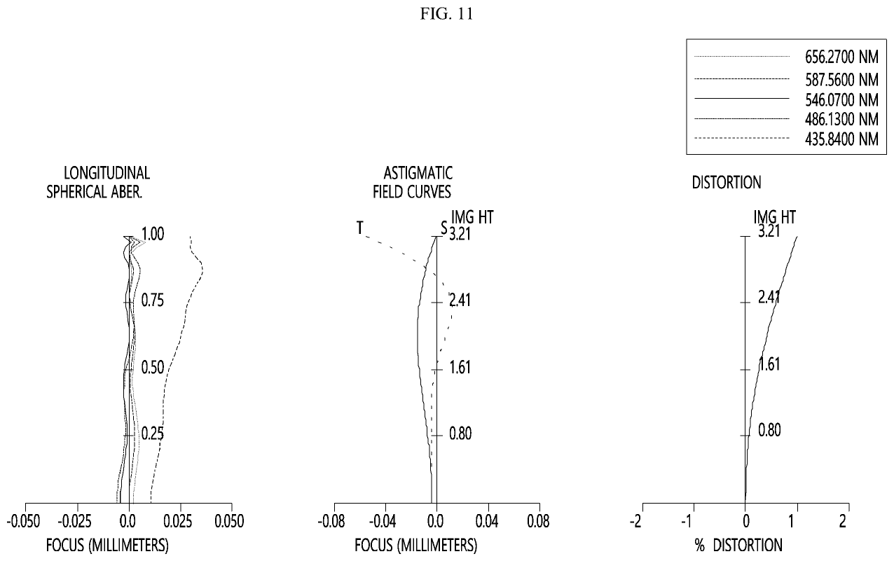

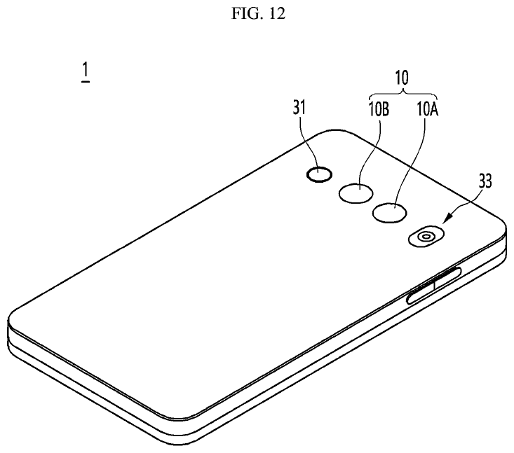

FIG. 1 is a configuration diagram of an optical system according to a first embodiment operating in the first mode, FIG. 2 is a diagram for explaining the total track length (TTL) and back focal length (BFL) of the optical system according to the first embodiment operating in the first mode, FIG. 3 is a configuration diagram of an optical system according to the first embodiment operating in the second mode, FIG. 4 is a diagram for explaining the total track length (TTL) and back focal length (BFL) of the optical system according to the first embodiment operating in the second mode, FIG. 5 is a diagram for explaining a lens of a non-circular shape, FIG. 6 is a graph of the aberration diagram when the optical system according to the first embodiment operates in the first mode, FIG. 7 is a graph of the aberration diagram when the optical system according to the first embodiment operates in the second mode, FIG. 8 is a configuration diagram of an optical system according to a second embodiment operating in the first mode, FIG. 9 is a configuration diagram of an optical system according to the second embodiment operates in the second mode, FIG. 10 is a graph of the aberration diagram when the optical system according to the second embodiment operates in the first mode, FIG. 11 is a graph of the aberration diagram when the optical system according to the second embodiment operates in the second mode, FIG. 12 is a diagram showing a camera module according to an embodiment applied to a mobile device.

Referring to FIGS. 1 to 7, the optical system 1000 according to an embodiment may include a plurality of lenses.

Although the drawing shows that the optical system 1000 includes six lenses, the embodiment is not limited thereto, and the optical system 1000 may include at least six lenses. Hereinafter, for convenience of explanation, the description will focus on the fact that the optical system 1000 includes six lenses.

The optical system 1000 may include a first lens 110, a second lens 120, a third lens 130, a fourth lens 140, a fifth lens 150 and a sixth lens 160.

In detail, the optical system 1000 may include the first lens 110, the second lens 120, the third lens 130, the fourth lens 140, the fifth lens 150 and the sixth lens 160 which are sequentially arranged from the object side to the image side.

In detail, the first lens 110, the second lens 120, the third lens 130, the fourth lens 140, the fifth lens 150, and the sixth lens 160 may be sequentially arranged along the optical axis OA of the optical system 1000.

In detail, the first lens 110, the second lens 120, the third lens 130, the fourth lens 140, the fifth lens 150, and the sixth lens 160 may be sequentially arranged so that the centers of the first lens 110, the second lens 120, the third lens 130, the fourth lens 140, the fifth lens 150 and the sixth lens 160 coincide with the optical axis OA of the optical system 1000.

Light corresponding to object information may pass through the first lens 110, the second lens 120, the third lens 130, the fourth lens 140, the fifth lens 150 and the sixth lens 160, and may be incident on the image sensor unit 300.

The first lens 110, the second lens 120, the third lens 130, the fourth lens 140, the fifth lens 150, and the sixth lens 160 may include an effective area and a non-effective area, respectively. The effective area may be defined as an area where light incident from each lens of the first lens 110, the second lens 120, the third lens 130, the fourth lens 140, the fifth lens 150 and the sixth lens 160 passes, and the incident light is refracted to implement optical characteristics.

A non-effective area may be placed around the effective area. A non-effective area may be placed on the periphery of the effective area. That is, the area excluding the effective area of each lens of the first lens 110, the second lens 120, the third lens 130, the fourth lens 140, the fifth lens 150 and the sixth lens 160 may be a non-effective area. A non-effective area may be an area where the light is not incident. That is, a non-effective area may be an area unrelated to the optical characteristics. Alternatively, a non-effective area may be an area where the light is incident but has no relation to optical characteristics. Additionally, a non-effective area may be an area fixed to a barrel (not shown) that accommodates the lens.

The optical system 1000 may include an aperture (not shown) to control the amount of incident light. The aperture may be disposed between two adjacent lenses among the first lens 110, the second lens 120, the third lens 130, the fourth lens 140, the fifth lens 150, and the sixth lens 160. For example, the aperture may be disposed between the first lens 110 and the second lens 120.

In addition, at least one lens among the first lens 110, the second lens 120, the third lens 130, the fourth lens 140, the fifth lens 150, or the sixth lens 160 may function as an aperture. For example, the object side or image side of any one of the first lens 110, the second lens 120, the third lens 130, the fourth lens 140, the fifth lens 150 or the sixth lens 160 may function as an aperture to adjust the amount of light.

The optical system 1000 may constitute an optical module 2000. In detail, the optical module 2000 may include the optical system 1000, an additional member disposed in front of the optical system 1000 before passing through the optical system 1000, and/or an additional member disposed behind the optical system 1000 and onto which light passing through the optical system 1000 is incident.

For example, the optical module 2000 may include the optical system 1000, an optical path change member disposed in front of the optical system 1000, an image sensor unit 300 and a filter unit 500 disposed behind the optical system 1000.

The image sensor unit 300 may detect light. In detail, the image sensor unit 300 may detect light that sequentially passes through the first lens 110, the second lens 120, the third lens 130, the fourth lens 140, the fifth lens 150 and the sixth lens 160. The image sensor unit 300 may include a charge coupled device (CCD) or a complementary metal oxide semiconductor (CMOS).

The filter unit 500 may be disposed between the optical system 1000 and the image sensor unit 300.

The filter unit 500 may be disposed between the sixth lens 160 that is the last lens closest to the image sensor unit 300 among the plurality of lenses 110, 120, 130, 140, 150, and 160 of the optical system 1000 and the image sensor unit 300. The filter unit 500 may include at least one of an optical filter such as an infrared filter or a cover glass.

The filter unit 500 may pass light in a set wavelength band and filter light in a different wavelength band. When the filter unit 500 includes an infrared filter, radiant heat emitted from external light may be blocked from being transmitted to the image sensor unit 300. Additionally, the filter unit 500 may transmit visible light and reflect infrared rays.

In addition, the optical module 2000 may further include an optical path change member (not shown).

The optical path changing member may change the path of light by reflecting light incident from the outside. The optical path changing member may include a reflector or prism. For example, the optical path changing member may include a right-angled prism. When the optical path changing member includes a right-angled prism, the optical path changing member may change the path of light by reflecting the path of incident light at an angle of 90°.

The optical path changing member may be disposed closer to the object side than the plurality of lenses. That is, when the optical module 2000 includes the optical path changing member, the optical path changing member, the first lens 110, the second lens 120, third lens 130, the fourth lens 140, the fifth lens 150 and the sixth lens 160 may be arranged in the order from the object side to the sensor.

The optical path change member may change the path of light incident from the outside in a set direction. For example, the optical path changing member may change the path of light incident on the optical path changing member in a first direction to a second direction (Optical axis OA direction in the drawing in the direction in which the plurality of lenses are spaced apart), which is the arrangement direction of the plurality of lenses.

When the optical module 2000 includes an optical path change member, the optical module 2000 may be applied to a folded camera that may reduce the thickness of the camera. In detail, when the optical module 2000 includes the optical path change member, the optical module 2000 may change light incident in a direction perpendicular to the surface of the applied electronic device to a direction parallel to the surface of the electronic device. Accordingly, the optical module 2000 including a plurality of lenses may have a thinner thickness within the electronic device, and thereby the electronic device may be implemented with a thinner thickness.

For example, when the optical module 2000 does not include the optical path change member, the plurality of lenses may be disposed within the electronic device extending in a direction perpendicular to the surface of the electronic device. Accordingly, the optical module 2000 including the plurality of lenses has a height perpendicular to the surface of the electronic device, and because of this, it may be difficult to make the optical module 2000 and the electronic device including the same thin.

However, when the optical module 2000 includes the optical path changing member, the plurality of lenses may be arranged to extend in a direction parallel to the surface of the device. That is, the optical module 2000 is arranged so that the optical axis OA is parallel to the surface of the device and may be applied to a folded camera. Accordingly, the optical module 2000 including the plurality of lenses may have a low height in a direction perpendicular to the surface of the device. Accordingly, the camera including the optical module 2000 may have a thin thickness within the device, and the thickness of the electronic device may also be reduced.

The lenses of the optical system 1000 and the optical module 2000 may move forward and backward along the optical axis. In detail, at least one lens among the lenses of the optical system 1000 and the optical module 2000 may move in the object side direction or the image side direction along the optical axis direction. Accordingly, the optical system 1000 and the optical module 2000 may adjust the focal length in infinity mode and short-distance mode.

FIGS. 1 to 4 are diagrams showing the configuration of two modes by moving lenses in the optical system 1000 and the optical module 2000 according to the first embodiment, respectively. In detail, FIGS. 1 and 2 are diagrams showing the configuration of a first mode defined as the infinity mode, and FIGS. 3 and 4 are diagrams showing the configuration of a second mode, which is defined as the short-distance mode.

Referring to FIGS. 1 to 4, the lenses of the optical system 1000 and the optical module 2000 may be divided into a plurality of lens groups depending on whether the lenses are moved. In detail, the lenses of the optical system 1000 and the optical module 2000 may be divided into a first lens group G1 defined as a fixed group lens that does not move, a second lens group G2 defined as a moving group lens that moves, and a third lens group G3 defined as a fixed group lens that does not move.

The first lens group G1 may include at least one lens. In detail, the first lens group G1 may include a plurality of lenses. In detail, the first lens group G1 may include a plurality of lenses spaced apart from each other at a predetermined distance. For example, the first lens group G1 may include the first lens 110, the second lens 120, and the third lens 130 that are arranged to be spaced apart from each other.

The plurality of lenses included in the first lens group G1 may be fixed without the spacing between the lenses changing due to changes in operation of the first mode and the second mode. For example, the distance between the first lens 110 and the second lens 120 and the distance between the second lens 120 and the third lens 130 may be fixed without changing due to changes in operation in the first mode and the second mode. Here, the distance between the pluralities of lenses may mean the distance in the optical axis OA direction between the centers of adjacent lenses.

The second lens group G2 may include at least one lens. In detail, the second lens group G2 may include a plurality of lenses. The number of lenses of the first lens group G1 and the number of lenses of the second lens group G2 may be the same or different. For example, the number of lenses of the second lens group G2 may be smaller than the number of lenses of the first lens group G1.

In detail, the second lens group G2 may include a plurality of lenses spaced apart at a predetermined distance. The number of lenses of the first lens group G1 and the number of lenses of the second lens group G2 may be different. For example, the second lens group G2 may include the fourth lens 140 and the fifth lens 150 arranged to be spaced apart from each other.

The plurality of lenses included in the second lens group G2 may be fixed without the spacing between the lenses changing due to changes in operation in the first mode and the second mode. For example, the distance between the fourth lens 140 and the fifth lens 150 may be fixed without changing depending on the first mode and the second mode operation. Here, the distance between the pluralities of lenses may mean the distance in the optical axis OA direction between the centers of adjacent lenses.

The third lens group G3 may include at least one lens. The number of lenses of the third lens group G3 may be the same as or different from the number of lenses of the first lens group G1 and the number of lenses of the second lens group G2. For example, the number of lenses of the third lens group G3 may be smaller than the number of lenses of the first lens group G1 and the second lens group G2.

At least one lens among the lenses included in the third lens group G3 may have a spherical surface shape.

For example, the third lens group G3 may include the sixth lens 160. In detail, the third lens group G3 may include a sixth lens 160 spaced apart from the fifth lens 150 of the second lens group G2. The sixth lens 160 may have a spherical surface shape.

The lenses included in the third lens group G3 may be fixed without moving due to changes in operation of the first mode and the second mode. For example, the distance between the sixth lens 160 and the second lens 120 and the distance between the second lens 120 and the third lens 130 may be fixed without changing due to changes in operation in the first mode and the second mode. Here, the distance between the pluralities of lenses may mean the distance in the optical axis OA direction between the centers of adjacent lenses.

The optical system 1000 and the second lens group G2 of the optical module 2000 may movable. In detail, the second lens group G2 may move along the optical axis direction. That is, the second lens group G2 may move along the optical axis direction toward the first lens group G1 or away from the third lens group G3. Also, the second lens group G2 may be moved along the optical axis direction, away from the first lens group G1 or closer to the third lens group G3.

In detail, a driving member (not shown) is connected to the optical system 1000 and the optical module 2000, and the second lens group G2 may move along the optical axis direction through the driving force of the driving member.

The driving member may move the second lens group G2 according to the first mode and the second mode. By this, at least one of the distance between the first lens group G1 and the second lens group G2 or the distance between the second lens group G2 and the third lens group G3 may be changed and the distance may be controlled. Here, the short distance of the second mode may mean a distance of about 40 mm or less. In detail, the short distance of the second mode may mean a distance of about 30 mm or less.

For example, as shown in FIGS. 1 to 4, the first lens group G1 and the third lens group G2 may be fixed, and the second lens group G2 may be movable by the driving force of the driving member. In this case, the distance between lenses included in each of the first lens group G1, the second lens group G2, and the third lens group G3 may not change.

In detail, when the second lens group G2 moves, the distance between the third lens group G2 and the image sensor unit 300 may be fixed regardless of the driving force of the driving member. Accordingly, the total track length (TTL) of the optical system 1000 and the optical module 2000 may be maintained, and the back focal length (BFL) of the optical system 1000 and the optical module 2000 may also be maintained.

For example, when the optical system 1000 and the optical module 2000 are converted from the first mode to the second mode, the second lens group G2 may move from the first lens group G1 toward the third lens group G3. In detail, the second lens group G2 may be moved to a position adjacent to the third lens group G3.

Conversely, when the optical system 1000 and the optical module 2000 are converted from the second mode to the first mode, the second lens group G2 is changed from the third lens group G3. It may move in the direction of the first lens group G1. In detail, the second lens group G2 may be moved to a position adjacent to the first lens group G1.

In addition, when the second lens group G2 moves, complex focal length of the first lens 110 and the second lens 120, complex focal length of the second lens 120 and the third lens 130, the complex focal length of the first lens 110, the second lens 120, and the third lens 130 may be maintained.

Additionally, when the second lens group G2 moves, the complex focal length of the fourth lens 140 and the fifth lens 120 may be maintained.

In addition, when the second lens group G2 moves, focal lengths of the third lens 130 and the fourth lens 140, focal lengths of the fifth lens 150 and the sixth lens 160, focal lengths of the second lens 120, the third lens 130, and the fourth lens 140, focal lengths of the third lens 130, the fourth lens 140, and the fifth lens 150, focal lengths of the first lens 110, the second lens 120, the third lens 130, and the fourth lens 140, focal lengths of the second lens 120, the third lens 130, the fourth lens 140, and the fifth lens 1500, focal lengths of the fourth lens 140, the fifth lens 150, and the sixth lens 160, focal length of the third lens 130, the fourth lens 140, the fifth lens 160, and the sixth lens 160, and the focal lengths of the second lens 120, the third lens 130, the fourth lens 140, the fifth lens 150, and the sixth lens 160 may change.

That is, a camera module including an optical system and an optical module according to an embodiment may control the position of at least one lens group among the plurality of lens group G1, G2 and G3 to change the distance between the lens groups G1, G2 and G3, the effective focal length (EFL) of the optical system 1000, and the complex focal length of the plurality of lenses. Accordingly, the camera module may control the effective focal length (EFL) depending on the distance from the subject, and may effectively provide an autofocus (AF) function for subjects located at infinity or short-distance.

The first lens group G1, the second lens group G2, and the third lens group G3 may have different refractive powers.

For example, the first lens group G1 and the second lens group G2 may have different refractive powers. In detail, the first lens group G1 may have positive (+) refractive power. Additionally, the second lens group G2 may have negative refractive power.

Additionally, the first lens group G1 and the third lens group G3 may have the same refractive power. In detail, the first lens group G1 and the third lens group G3 may have positive (+) refractive power.

Additionally, the second lens group G2 and the third lens group G3 may have different refractive powers. In detail, the second lens group G2 may have negative (−) refractive power. Additionally, the third lens group G2 may have positive (+) refractive power.

The first lens group G1, the second lens group G2, and the third lens group G3 may have different focal lengths. In detail, the focal length of the first lens group G1 and the combined focal length of the second lens group G2 and the third lens group G3 may satisfy Equation 1 below.

$$0.6 < \vert f\_ 1 / f\_ 23 \vert < 1.4 \qquad [ Equation 1 ]$$

(In Equation 1, f_1 is the focal length of the first lens group, and f_23 is the combined focal length of the second lens group and the third lens group.)

As the combined focal length of the first lens group G1, the second lens group G2, and the third lens group G3 satisfies the ratio of above range, the optical system 1000 and the optical module 2000 may provide an autofocus (AF) function for objects located at infinity or a short distance. In addition, as the first lens group G1, the second lens group G2, and the third lens group G3 satisfy the focal length ratio of the above range, the amount of curvature that occurs depending on the moving distance of the moving lens group may be minimized. Accordingly, the optical system 1000 and the optical module 2000 may minimize deterioration of image quality in the peripheral area when the focus changes from infinity to short-distance.

Hereinafter, each lens included in the first lens group G1, the second lens group G2, and the third lens group G3 and the relationships between the lenses will be described in detail.

The first lens 110 may have positive (+) refractive power at the optical axis. The first lens 110 may include plastic or glass. For example, the first lens 110 may be made of plastic.

The first lens 110 may include a first surface S1 defined as the object side and a second surface S2 defined as the image side. The first surface S1 may be convex with respect to the object side of the optical axis, and the second surface S2 may be convex with respect to the image side of the optical axis. That is, the first lens 110 may have an overall shape in which both surfaces are convex at the optical axis.

At least one of the first surface S1 or the second surface S2 may be an aspherical surface. For example, both the first surface S1 and the second surface S2 may be aspherical surfaces.

The size of the clear aperture of the first surface S1 of the first lens 110 on the object side may be different from the size of the clear aperture of the second surface S2 on the image side. In detail, the clear aperture size of the first surface S1 of the first lens 110 may be larger than the clear aperture size of the second surface S2.

The second lens 120 may have negative refractive power at the optical axis. The second lens 120 may include plastic or glass. For example, the second lens 120 may be made of plastic.

The second lens 120 may include a third surface S3 defined as the object side and a fourth surface S4 defined as the image side. The third surface S3 may be concave with respect to the object side of the optical axis, and the fourth surface S4 may be concave with respect to the image side of the optical axis. That is, the second lens 120 may have an overall shape in which both surfaces are convex at the optical axis.

At least one of the third surface S3 or the fourth surface S4 may be an aspherical surface. For example, both the third surface S3 and the fourth surface S4 may be aspherical surfaces.

The size of the clear aperture of the third surface S3 of the second lens 120 on the object side may be different from the size of the clear aperture of the fourth surface S4 of the image side. In detail, the clear aperture size of the third surface S3 of the second lens 120 may be smaller than the clear aperture size of the fourth surface S4.

The third lens 130 may have positive (+) refractive power at the optical axis. The third lens 130 may include plastic or glass. For example, the third lens 130 may be made of plastic.

The third lens 130 may include a fifth surface S5 defined as the object side and a sixth surface S6 defined as the image side. The fifth surface S5 may be convex with respect to the object side of the optical axis, and the sixth surface S6 may be convex with respect to the image side of the optical axis. That is, the third lens 130 may have an overall shape in which both surfaces are convex at the optical axis.

At least one of the fifth surface S5 or the sixth surface S6 may be an aspherical surface. For example, both the fifth surface S5 and the sixth surface S6 may be aspherical surfaces.

The size of the clear aperture of the fifth surface S5 of the object side and the size of the clear aperture of the sixth surface S6 of the image side of the third lens 130 may be different. In detail, the clear aperture size of the fifth surface S5 of the third lens 130 may be larger than the clear aperture size of the sixth surface S6.

The fourth lens 140 may have negative refractive power at the optical axis. The fourth lens 140 may include plastic or glass. For example, the fourth lens 140 may be made of plastic.

The fourth lens 140 may include a seventh surface S7 defined as the object side and an eighth surface S8 defined as the image side. The seventh surface S7 may be concave with respect to the object side on the optical axis, and the eighth surface S8 may be concave with respect to the image side on the optical axis. That is, the fourth lens 140 may have an overall shape in which both surfaces are convex at the optical axis.

At least one of the seventh surface S7 or the eighth surface S8 may be an aspherical surface. For example, both the seventh surface S7 and the eighth surface S8 may be aspherical surfaces.

The size of the clear aperture of the seventh surface S7 of the fourth lens 140 on the object side may be different from the size of the clear aperture of the eighth surface S8 on the image side. In detail, the clear aperture size of the seventh surface S7 of the fourth lens 140 may be larger than the clear aperture size of the eighth surface S8.

The fifth lens 150 may have positive (+) refractive power at the optical axis. The fifth lens 150 may include plastic or glass. For example, the fifth lens 150 may be made of plastic.

The fifth lens 150 may include a ninth surface S9 defined as the object side and a tenth surface S10 defined as the image side. The ninth surface S9 may be concave with respect to the object side of the optical axis, and the tenth surface S10 may be convex with respect to the image side of the optical axis. That is, the fifth lens 150 may have an overall meniscus shape that is convex on the image side.

At least one of the ninth surface S9 or the tenth surface S10 may be an aspherical surface. For example, both the ninth surface S9 and the tenth surface S10 may be aspherical surfaces.

The size of the clear aperture of the ninth surface S9 on the object side of the fifth lens 150 may be different from the size of the clear aperture of the tenth surface S10 on the image side. In detail, the clear aperture size of the ninth surface S9 of the fifth lens 150 may be smaller than the clear aperture size of the tenth surface S6.

The sixth lens 160 may have positive (+) refractive power at the optical axis. The sixth lens 160 may include plastic or glass. For example, the sixth lens 160 may be made of plastic.

The sixth lens 160 may include an eleventh surface S11 defined as the object side and a twelfth surface S12 defined as the image side. The eleventh surface S11 may be concave with respect to the object side of the optical axis, and the twelfth surface S12 may be convex with respect to the image side of the optical axis. That is, the sixth lens 160 may have an overall meniscus shape that is convex on the image side.

At least one of the eleventh surface S11 and the twelfth surface S12 may be a spherical surface. For example, both the eleventh surface S11 and the twelfth surface S12 may be spherical surfaces.

The size of the clear aperture of the eleventh surface S11 on the object side of the sixth lens 160 may be different from the size of the clear aperture of the twelfth surface S12 on the image side. In detail, the clear aperture size of the eleventh surface S11 of the sixth lens 160 may be smaller than the clear aperture size of the twelfth surface S12.

In addition, the size of clear aperture of the eleventh surface S11 on the object side size of the clear aperture of the twelfth surface S12 on the image side of the sixth lens 160 may be larger than the clear aperture sizes of the first lens 110, the second lens 120, the third lens 130, the fourth lens 140 and the fifth lens 150. In detail, the size of clear aperture of the eleventh surface S11 on the object side size of the clear aperture of the twelfth surface S12 on the image side of the sixth lens 160 may be larger than the clear aperture sizes of the first lens 110, the second lens 120, the third lens 130, the fourth lens 140 and the fifth lens 150, respectively.

At least one lens among the plurality of lenses may have a non-circular shape. For example, at least one lens among the lenses included in the first lens group G1 may have a non-circular shape.

As an example, the first lens 110 may have a non-circular shape. In detail, the first surface S1 and the second surface S2 of the first lens 110 may have a non-circular shape, and the third to twelfth surfaces S3, S4, S5, S6, S7, S8, S9, S10, S11 and S12 of the second to sixth lenses 120, 130, 140, 150 and 160 may have a circular shape. That is, when each of the first surface S1 and the second surface S2 is viewed from the front corresponding to the optical axis OA, the effective area of each lens surface may have a non-circular shape.

Referring to FIG. 5, the effective areas of each of the first surface S1 and second surface S2 of the first lens 110 may include a first to fourth corners A1, A2, A3 and A4.

The first corner A1 and the second corner A2 may be corners facing each other in a first direction (x-axis direction) perpendicular to the optical axis OA. The first corner A1 and the second corner A2 may have a curved shape. The first corner A1 and the second corner A2 may be provided in a curved shape with the same length and curvature. That is, the first corner A1 and the second corner A2 may have a symmetrical shape with respect to an imaginary line passing through the optical axis OA and extending in the second direction (y-axis direction).

Additionally, the third corner A3 and the fourth corner A4 may be corners facing the optical axis OA and a second direction (y-axis direction) perpendicular to the first direction. The third corner A3 and the fourth corner A4 may be corners connecting the ends of the first corner A1 and the second corner A2. The third corner A3 and the fourth corner A4 may have a straight line shape. The third corner A3 and the fourth corner A4 may have the same length and be parallel to each other. That is, the third corner A3 and the fourth corner A4 may have a symmetrical shape with respect to an imaginary line passing through the optical axis OA and extending in the first direction (x-axis direction).

The first surface S1 and the second surface S2 may have a non-circular shape, for example, a D-cut shape, by including the first to fourth corners A1, A2, A3 and A4 described above.

The first surface S1 and the second surface S2 may have a non-circular shape as described above during the manufacturing process of the first lens 110. For example, if the first lens 110 includes a plastic material, it may be manufactured into a non-circular shape described above during the injection process.

Alternatively, the first lens 110 may be manufactured into a circular shape through an injection process, and in the subsequent cutting process, partial areas of the first surface S1 and the second surface S2 may be cut to have the third corner A3 and the fourth corner A4.

Accordingly, the effective areas of each of the first surface S1 and the second surface S2 may have a predetermined size. For example, a length of a virtual of first straight line (clear aperture; CA) passing through the optical axis OA and connecting the first corner A1 and the second corner A2 may be longer than a length of a virtual second straight line (clear height; CH) that passes through the optical axis OA and connects the third corner A3 and the fourth corner A4. Here, the length of the first straight line CA may mean the maximum clear aperture size CA of each of the first surface S1 and the second surface S2, and the length of the second straight line CH may mean the minimum clear aperture size CH of each of the first surface S1 and the second surface S2. For example, the minimum clear aperture size CH of the first surface S1 and the second surface S2 may be about 5 mm.

In addition, in the previous description, it was explained that the effective areas of the first and second surfaces S1 and S2 have a non-circular shape, but it is not limited to this, the effective area of each of the first surface S1 and the second surface S2 may have a circular shape, and a non-effective areas of each of the first surface S1 and the second surface S2 may have a non-circular shape.

The optical system 1000 and the optical module 2000 according to the embodiment may satisfy at least one of the equations described below. Accordingly, the optical system 1000 and the optical module 2000 according to the embodiment may improve aberration characteristics and have improved optical characteristics. Additionally, the embodiment may effectively provide an autofocus (AF) function for subjects located from a short distance to infinity, and may be provided in a slimmer and more compact manner.

$$\begin{matrix}CA\_L6S1 > CA\_L1S1 , \\ CA\_L6S1 > CA\_L1S2\end{matrix} \qquad [ Equation 2 ]$$

(In Equation 2, CA_L6S1 means the size of the maximum clear aperture (CA) on the object side of the sixth lens, and CA_L1S1 means the size of the maximum clear aperture on the object side of the first lens, CA_L1S2 means the size of the maximum clear aperture on the image side of the first lens.)

Equation 2 may be related to the amount of light incident on the image sensor unit from the optical system and optical module.

In detail, as the optical system and optical module satisfy Equation 2 above, the amount of light incident on the image sensor unit may be increased, and the resolution of the optical module and camera module may be improved.

$$\begin{matrix}CA\_L6S2 > CA\_L1S1 , \\ CA\_L6S2 > CA\_L1S2\end{matrix} \qquad [ Equation 3 ]$$

(In Equation 3, CA_L6S2 means the size of the maximum clear aperture on the image side of the sixth lens, CA_L1S1 means the size of the maximum clear aperture on the object side of the first lens, CA_L1S2 means the size of the maximum clear aperture on the image side of the first lens.)

Equation 3 may be related to the amount of light incident on the image sensor unit from the optical system and optical module.

In detail, as the optical system and optical module satisfy Equation 3 above, the amount of light incident on the image sensor unit may be increased, and the resolution of the optical module and camera module may be improved.

$$0 < \vert P 6 \vert < \vert P 1 \vert , \vert P 2 \vert , \vert P 3 \vert , \vert P 4 \vert , \vert P 5 \vert \qquad [ Equation 4 ]$$

(In Equation 4, P1, P2, P3, P4, P5, and P6 mean the refractive power of the first lens, second lens, third lens, fourth lens, fifth lens, and sixth lens, respectively.)

Equation 4 is related to the spherical surface aberration of the optical system and/or optical module according to the embodiment.

If the optical system and/or optical module according to the embodiment does not satisfy Equation 4 above, as the size and ratio of the curvature radius of the first to sixth lenses change, spherical surface aberrations at the center and the periphery of each lens and the entire optical system may increase, thereby deteriorating the overall optical characteristics.

$$0 \text{.6} < \vert EFL\_ 2 / f 6 \vert / \vert EFL\_ 1 / f 6 \vert < 0. 7 \qquad [ Equation 5 ]$$

(In Equation 5, EFL_1 is the effective focal length at the maximum moving distance of the second lens group in the first mode, EFL_2 is the effective focal length at the maximum moving distance of the second lens group in the second mode, f6 means the focal length of the sixth lens.)

Equation 5 is related to the reduction of curvature aberration in the first mode and the second mode according to the movement of the second lens group.

If the optical system and/or optical module according to the embodiment does not satisfy Equation 5 above, the ratio of the focal length of the sixth lens of the second lens group and the effective focal length of the entire optical system may be changed, by this, curvature aberration in the first mode and the second mode may increase due to movement of the second lens group, thereby deteriorating optical characteristics.

$$1. < \vert EFL\_ 2 / f 34 \_ 2 \vert / \vert EFL\_ 1 / f 34 \_ 1 \vert < 2. 5 \qquad [ Equation 6 ]$$

(In Equation 6, EFL_1 is the effective focal length at the maximum moving distance of the second lens group in the first mode, EFL_2 is the effective focal length at the maximum moving distance of the second lens group in the second mode, f34_1 is the complex focal length of the third lens and the fourth lens at the maximum moving distance of the second lens group in the first mode, f34_2 means the complex focal length of the third lens and the fourth lens at the maximum moving distance of the second lens group in the second mode.)

Equation 6 is related to the reduction of curvature aberration in the first mode and the second mode according to the movement of the second lens group.

When the optical system and/or optical module according to the embodiment does not satisfy Equation 6 above, the ratio of the effective focal length of the entire optical system and the complex focal length of the third lens and the fourth lens, which changes according to the movement of the second lens group, may change, by this, curvature aberration in the first mode and the second mode may increase due to movement of the second lens group, thereby deteriorating optical characteristics.

$$0 \text{.6} < \vert EFL\_ 2 / f 56 \_ 2 \vert / \vert EFL\_ 1 / f 56 \_ 1 \vert < 0. 7 \qquad [ Equation 7 ]$$

(In Equation 7, EFL_1 is the effective focal length at the maximum moving distance of the second lens group in the first mode, EFL_2 is the effective focal length at the maximum moving distance of the second lens group in the second mode, f56_1 is the complex focal length of the 5th lens and the 6th lens at the maximum moving distance of the second lens group in the first mode, f56_2 means the complex focal length of the fifth lens and the sixth lens at the maximum moving distance of the second lens group in the second mode.)

Equation 7 is related to the reduction of curvature aberration in the first mode and the second mode according to the movement of the second lens group.

When the optical system and/or optical module according to the embodiment does not satisfy Equation 7 above, the ratio of the effective focal length of the entire optical system and the complex focal length of the fifth and sixth lenses, which changes according to the movement of the second lens group, may change, by this, curvature aberration in the first mode and the second mode may increase due to movement of the second lens group, thereby deteriorating optical characteristics.

$$0.4 < \vert EFL\_ 2 / f 234 \_ 2 \vert / \vert EFL\_ 1 / f 234 \_ 1 \vert < 0. 6 \qquad [ Equation 8 ]$$

(In Equation 8, EFL_1 is the effective focal length at the maximum moving distance of the second lens group in the first mode, EFL_2 is the effective focal length at the maximum moving distance of the second lens group in the second mode, f234_1 is the complex focal length of the second lens, third lens, and fourth lens at the maximum moving distance of the second lens group in the first mode, f234_2 means the complex focal length of the second lens, third lens, and fourth lens at the maximum moving distance of the second lens group in the second mode.)

Equation 8 is related to the reduction of curvature aberration in the first mode and the second mode according to the movement of the second lens group.

When the optical system and/or optical module according to the embodiment does not satisfy Equation 8 above, the effective focal length of the entire optical system and the ratio of the complex focal length of the second lens, third lens, and fourth lens, which change according to the movement of the second lens group, may change, by this, curvature aberration in the first mode and the second mode may increase due to movement of the second lens group, thereby deteriorating optical characteristics.

$$0 \text{.8} < \vert EFL\_ 2 / f 345 \_ 2 \vert / \vert EFL\_ 1 / f 345 \_ 1 \vert < 1. \qquad [ Equation 9 ]$$

(In Equation 9, EFL_1 is the effective focal length at the maximum moving distance of the second lens group in the first mode, EFL_2 is the effective focal length at the maximum moving distance of the second lens group in the second mode, f345_1 is the complex focal length of the third lens, fourth lens, and fifth lens at the maximum moving distance of the second lens group in the first mode, f345_2 refers to the complex focal length of the third lens, fourth lens, and fifth lens at the maximum moving distance of the second lens group in the second mode.)

Equation 9 is related to the reduction of curvature aberration in the first mode and the second mode according to the movement of the second lens group.

If the optical system and/or optical module according to the embodiment does not satisfy Equation 9 above, the ratio of the effective focal length of the entire optical system and the complex focal length of the third lens, fourth lens, and fifth lens, which changes according to the movement of the second lens group, may change, by this, curvature aberration in the first mode and the second mode may increase due to movement of the second lens group, thereby deteriorating optical characteristics.

$$1.5 < \vert EFL\_ 2 / f 1234 \_ 2 \vert / \vert EFL\_ 1 / f 1234 \_ 1 \vert < 3. \qquad [ Equation 10 ]$$

(In Equation 10, EFL_1 is the effective focal length at the maximum moving distance of the second lens group in the first mode, EFL_2 is the effective focal length at the maximum moving distance of the second lens group in the second mode, f1234_1 is the complex focal length of the first lens, second lens, third lens, and fourth lens at the maximum moving distance of the second lens group in the first mode, f1234_2 means the complex focal length of the first lens, second lens, third lens, and fourth lens at the maximum moving distance of the second lens group in the second mode.)

Equation 10 is related to the reduction of curvature aberration in the first mode and the second mode according to the movement of the second lens group.

If the optical system and/or optical module according to the embodiment does not satisfy Equation 10 above, the effective focal length of the entire optical system and the ratio of the complex focal lengths of the first lens, second lens, third lens, and fourth lens, which change according to the movement of the second lens group, may change, by this, curvature aberration in the first mode and the second mode may increase due to movement of the second lens group, thereby deteriorating optical characteristics.

$$0 \text{.3} < \vert EFL\_ 2 / f 2345 \_ 2 \vert / \vert EFL\_ 1 / f 2345 \_ 1 \vert < 0. 5 \qquad [ Equation 11 ]$$

(In Equation 11, EFL_1 is the effective focal length at the maximum moving distance of the second lens group in the first mode, EFL_2 is the effective focal length at the maximum moving distance of the second lens group in the second mode, f2345_1 is the complex focal length of the second lens, third lens, fourth lens, and fifth lens at the maximum moving distance of the second lens group in the first mode, f2345_2 means the complex focal length of the second lens, third lens, fourth lens, and fifth lens at the maximum moving distance of the second lens group in the second mode.)

Equation 11 is related to the reduction of curvature aberration in the first mode and the second mode according to the movement of the second lens group.

If the optical system and/or optical module according to the embodiment does not satisfy Equation 11 above, the effective focal length of the entire optical system and the ratio of the complex focal length of the second lens, third lens, fourth lens, and fifth lens, which change according to the movement of the second lens group, may change, by this, curvature aberration in the first mode and the second mode may increase due to movement of the second lens group, thereby deteriorating optical characteristics.

$$0 \text{.6} < \vert EFL\_ 2 / f 456 \_ 2 \vert / \vert EFL\_ 1 / f 456 \_ 1 \vert < 0. 7 \qquad [ Equation 12 ]$$

(In Equation 12, EFL_1 is the effective focal length at the maximum moving distance of the second lens group in the first mode, EFL_2 is the effective focal length at the maximum moving distance of the second lens group in the second mode, f456_1 is the complex focal length of the fourth lens, fifth lens, and sixth lens at the maximum moving distance of the second lens group in the first mode, f456_2 means the complex focal length of the fourth lens, fifth lens, and sixth lens at the maximum moving distance of the second lens group in the second mode.)

Equation 12 is related to the reduction of curvature aberration in the first mode and the second mode according to the movement of the second lens group.

If the optical system and/or optical module according to the embodiment does not satisfy Equation 8 above, the effective focal length of the entire optical system and the ratio of the complex focal length of the fourth lens, fifth lens, and sixth lens, which change according to the movement of the second lens group, may change, by this, curvature aberration in the first mode and the second mode may increase due to movement of the second lens group, thereby deteriorating optical characteristics.

$$0 \text{.9} < \vert EFL\_ 2 / f 3456 \_ 2 \vert / \vert EFL\_ 1 / f 3456 \_ 1 \vert < 1. \qquad [ Equation 13 ]$$

(In Equation 13, EFL_1 is the effective focal length at the maximum moving distance of the second lens group in the first mode, EFL_2 is the effective focal length at the maximum moving distance of the second lens group in the second mode, f3456_1 is the complex focal length of the third lens, fourth lens, fifth lens, and sixth lens at the maximum moving distance of the second lens group in the first mode, f3456_2 means the complex focal length of the third lens, fourth lens, fifth lens, and sixth lens at the maximum moving distance of the second lens group in the second mode.)

Equation 13 is related to the reduction of curvature aberration in the first mode and the second mode according to the movement of the second lens group.

If the optical system and/or optical module according to the embodiment does not satisfy Equation 13 above, the effective focal length of the entire optical system and the ratio of the complex focal lengths of the third lens, fourth lens, fifth lens, and sixth lens, which change according to the movement of the second lens group, may change, by this, curvature aberration in the first mode and the second mode may increase due to movement of the second lens group, thereby deteriorating optical characteristics.

$$0 \text{.3} < \vert EFL\_ 2 / f 23456 \_ 2 \vert / \vert EFL\_ 1 / f 23456 \_ 1 \vert < 0. 5 \qquad [ Equation 14 ]$$

(In Equation 14, EFL_1 is the effective focal length at the maximum moving distance of the second lens group in the first mode, EFL_2 is the effective focal length at the maximum moving distance of the second lens group in the second mode, f23456_1 is the complex focal length of the second lens, third lens, fourth lens, fifth lens, and sixth lens at the maximum moving distance of the second lens group in the first mode, f23456_2 means the complex focal length of the second lens, third lens, fourth lens, fifth lens, and sixth lens at the maximum moving distance of the second lens group in the second mode.)

Equation 14 is related to the reduction of curvature aberration in the first mode and the second mode according to the movement of the second lens group.

If the optical system and/or optical module according to the embodiment does not satisfy Equation 14 above, the effective focal length of the entire optical system and the ratio of the complex focal lengths of the second lens, third lens, fourth lens, fifth lens, and sixth lens that change according to the movement of the second lens group may change, by this, curvature aberration in the first mode and the second mode may increase due to movement of the second lens group, thereby deteriorating optical characteristics.

$$\vert R 1 \vert , \vert R 2 \vert , \vert R 3 \vert , \vert R 4 \vert , \vert R 5 \vert , \vert R 6 \vert , \vert R 7 \vert , \vert R 8 \vert , \vert R 9 \vert , \vert R 10 \vert < \vert R 11 \vert , \vert R 12 \vert \qquad [ Equation 15 ]$$

(In Equation 15, R1 is the radius of curvature of the first surface of the first lens, R2 is the radius of curvature of the second surface of the first lens, R3 is the radius of curvature of the third surface of the second lens, R4 is the radius of curvature of the fourth surface of the second lens, R5 is the radius of curvature of the fifth surface of the third lens, R6 is the radius of curvature of the sixth surface of the third lens, R7 is the radius of curvature of the seventh surface of the fourth lens, R8 is the radius of curvature of the eighth surface of the fourth lens, R9 is the radius of curvature of the ninth surface of the fifth lens, R10 is the radius of curvature of the tenth surface of the fifth lens, R11 is the radius of curvature of the eleventh surface of the sixth lens, R12 is the radius of curvature of the twelfth surface of the sixth lens.)

Equation 15 is related to the spherical surface aberration of the optical system and/or optical module according to the embodiment.

If the optical system and/or optical module according to the embodiment does not satisfy Equation 15 above, as the size and ratio of the curvature radii of the first to sixth lenses change, spherical surface aberrations at the center and the periphery of each lens and the entire optical system may increase, thereby deteriorating the overall optical characteristics.

$$2.5 < T34\_ 2 / T 34 \_ 1 < 6.5 \qquad [ Equation 16 ]$$

(In Equation 16, T34_1 is the distance between the third lens and the fourth lens at the maximum moving distance of the second lens group in the first mode, T34_2 is the distance between the third lens and the fourth lens at the maximum moving distance of the second lens group in the second mode.)

Equation 16 may be related to the driving force and optical characteristics of the optical system and/or optical module according to the embodiment.

If the optical system and optical module according to the embodiment do not satisfy Equation 16 above, as the moving distance of the second lens group moving in the first mode and the second mode increases, power consumption of the optical system and optical module may increase, Additionally, the moving distance of the second lens group moving in the first mode and the second mode may decrease, thereby increasing the amount of curvature aberration of the optical system and optical module, thereby reducing optical characteristics.

$$0.7 < T56\_ 2 / T56\_ 1 < 0.8 \qquad [ Equation 17 ]$$

(In Equation 17, T56_1 is the distance between the 5th lens and the 6th lens at the maximum moving distance of the second lens group in the first mode, T56_2 is the distance between the fifth lens and the sixth lens at the maximum moving distance of the second lens group in the second mode.)

Equation 17 may be related to the driving force and optical characteristics of the optical system and/or optical module according to the embodiment.

If the optical system and optical module according to the embodiment do not satisfy Equation 17 above, as the moving distance of the second lens group moving in the first mode and the second mode increases, power consumption of the optical system and optical module may increase, Additionally, the moving distance of the second lens group moving in the first mode and the second mode may decrease, thereby increasing the amount of curvature aberration of the optical system and optical module, thereby reducing optical characteristics.

$$3 < \vert T34\_ 1 - T56\_ 1 \vert - \vert T34\_ 2 - T56\_ 2 \vert < 4 \qquad [ Equation 18 ]$$

(In Equation 18, T34_1 is the distance between the 5th lens and the 6th lens in the first mode, T34_2 is the distance between the 5th lens and the 6th lens in the second mode, T56_1 is the distance between the 5th lens and the 6th lens in the first mode, T56_2 is the distance between the fifth lens and the sixth lens in the second mode.)

Equation 18 may be related to the driving force and optical characteristics of the optical system and/or optical module according to the embodiment.

If the optical system and optical module according to the embodiment do not satisfy Equation 18 above, as the moving distance of the second lens group moving in the first mode and the second mode increases, power consumption of the optical system and optical module may increase, Additionally, the moving distance of the second lens group moving in the first mode and the second mode may decrease, thereby increasing the amount of curvature aberration of the optical system and optical module, thereby reducing optical characteristics.

$$1.5 < EFL\_ 1 / EFL\_ 2 < 1.7 \qquad [ Equation 19 ]$$

(In Equation 19, EFL_1 is the effective focal length at the maximum moving distance of the second lens group in the first mode, and EFL_2 is the effective focal length at the maximum moving distance of the second lens group in the second mode.)

Equation 19 is related to the reduction of curvature aberration in the first mode and the second mode according to the movement of the second lens group.

If the optical system and optical module according to the embodiment do not satisfy Equation 19 above, the ratio of the effective focal lengths of the optical system in the first mode and the second mode may be changed, by this, curvature aberration in the first mode and the second mode may increase due to movement of the second lens group, thereby deteriorating optical characteristics.

$$\begin{matrix}N 1 < N 2 , \\ N 4 , N 6 < N 5\end{matrix} \qquad [ Equation 20 ]$$

(In Equation 20, N1 is the refractive index of the first lens, N2 is the refractive index of the second lens, N4 is the refractive index of the fourth lens, N5 is the refractive index of the fifth lens, N6 is the refractive index of the 6th lens.)

$$n\_G3 \leq n\_G2 \leq n\_G1 \qquad [ Equation 21 ]$$

(In Equation 2, n_G1 is the number of lenses included in the first lens group, n_G2 is the number of lenses included in the second lens group G2, n_G3 is the number of lenses included in the third lens group.)

$$8 < TTL / md 1 < 12 \qquad [ Equation 22 ]$$

(In Equation 22, md1 means the moving distance of the second lens group G2 when changing from infinity mode (first mode) to short-distance mode (second mode) or from short-distance mode (second mode) to infinity mode (first mode), Total track length (TTL) refers to the distance in the optical axis OA direction from the vertex of the object side of the lens closest to the object among the plurality of lenses to the image surface of the image sensor unit.)

Equation 22 is related to the driving force and optical characteristics of the optical system according to the moving distance of the second lens group.

If the optical system and optical module according to the embodiment do not satisfy Equation 20 above, as the moving distance of the second lens group moving in the first mode and the second mode increases, power consumption of the optical system and optical module may increase, Additionally, the moving distance of the second lens group moving in the first mode and the second mode may decrease, thereby increasing the amount of curvature aberration of the optical system and optical module, thereby reducing optical characteristics.

$$0.1 < md 1 / ImgH < 0.3 \qquad [ Equation 23 ]$$

(In Equation 23, md1 means the moving distance of the second lens group G2 when changing from infinity mode (first mode) to short-distance mode (second mode) or from short-distance mode (second mode) to infinity mode (first mode), ImgH refers to the vertical distance of the optical axis OA from the 0 field area of the image sensor unit to the 1.0 field area of the image sensor unit.

That is, the ImgH refers to the diagonal length of the effective area of the image sensor unit.)

Equation 23 is related to the driving force and optical characteristics of the optical system according to the moving distance of the second lens group.

If the optical system and optical module according to the embodiment do not satisfy Equation 23 above, as the moving distance of the second lens group moving in the first mode and the second mode increases, power consumption of the optical system and optical module may increase, Additionally, the moving distance of the second lens group moving in the first mode and the second mode may decrease, thereby increasing the amount of curvature aberration of the optical system and optical module, thereby reducing optical characteristics.

Additionally, the optical system according to the embodiment may have improved optical characteristics by minimizing the amount of curvature that occurs due to movement of the lens group when the focus changes in the range from infinity to short-distance.

Hereinafter, the optical system and optical module according to the first embodiment will be described in more detail. In detail, in the optical system 1000 and the optical module 2000, the plurality of lenses 100 when the first lens group G1 and the third lens group G3 are fixed and the second lens group G2 is provided to be movable will now be described in detail.

TABLE 1

| | | | Lens | | | |
|---|---|---|---|---|---|---|
| | | | thickness | | | |
| | | Radius of | and lens | | | Size of clear |
| | | curvature | distance | Refractive | Abbe's | aperture |
| | Surface | (mm) | (mm) | index | Number | (mm) |
| First lens | First surface | 6.6285 | 1.4028 | 1.5348 | 55.7000 | 5.4 |
| | Second surface | −25.0476 | 0.26160 | | | 5.0767 |
| Second lens | Third surface | −12.8346 | 0.3700 | 1.5880 | 28.3000 | 3.7571 |
| | Fourth surface | 3.6092 | 0.1000 | | | 3.8297 |
| Third lens | Fifth surface | 3.1945 | 1.2989 | 1.5348 | 55.7000 | 3.889 |
| | Sixth surface | −4.2649 | 0.3587 | | | 3.8293 |
| Fourth lens | Seventh surface | −11.8589 | 0.3700 | 1.5348 | 55.7000 | 3.0369 |
| | Eighth surface | 3.1218 | 0.6068 | | | 2.613 |
| Fifth lens | Ninth surface | 29.7485 | 2.1543 | 1.6610 | 20.4000 | 2.56 |
| | Tenth surface | 9.1599 | 6.2226 | | | 3.7214 |
| Sixth lens | Eleventh surface | −100.000 | 0.5000 | 1.5348 | 55.7000 | 5.8919 |
| | Twelfth surface | −100.000 | | | | 6.0166 |

TABLE 2

| | |
|---|---|
| TTL1 | 17.2000 |
| BFL1 | 0.7900 |
| EFL1 | 17.1000 |
| ImgH | 6.4280 |
| First distance (d1) | 0.3587 |
| Second distance (d2) | 6.2226 |

Table 1 provides lens information when the camera module operates in the first mode, which is infinity mode. In detail, Table 1 shows the radius of curvature, thickness of each lens, center distance on the optical axis between each lens, refractive index, Abbe's Number, size of clear aperture of the first to sixth lenses 110, 120, 130, 140, 150, and 160 in the infinity mode.

Additionally, Table 2 shows data on the size of the image sensor unit, TTL when operating in infinity mode, BFL BFL1, EFL EFL1, and the distance between the moving group and the fixed group.

Referring to Table 1, the first lens 110 of the optical system 1000 according to the embodiment may have positive (+) refractive power. The first surface S1 of the first lens 110 may be convex with respect to the object side on the optical axis, and the second surface S2 may be convex with respect to the image side on the optical axis. The first lens 110 may have a convex shape on both surfaces. The first surface S1 may be an aspherical surface, and the second surface S2 may be an aspherical surface.

The second lens 120 may have negative (−) refractive power. The third surface S3 of the second lens 120 may be concave in the optical axis with respect to the object side, and the fourth surface S4 may be concave in the optical axis with respect to the image side. The second lens 120 may have a concave shape on both surfaces. The third surface S3 may be an aspherical surface, and the fourth surface S4 may be an aspherical surface.

The third lens 130 may have positive (+) refractive power. The fifth surface S5 of the third lens 130 may be convex with respect to the object side on the optical axis, and the sixth surface S6 may be convex with respect to the image side on the optical axis. The third lens 130 may have a convex shape on both surfaces. The fifth surface S5 may be an aspherical surface, and the sixth surface S6 may be an aspherical surface.

The fourth lens 140 may have negative (−) refractive power. The seventh surface S7 of the fourth lens 140 may be concave with respect to the object side on the optical axis, and the eighth surface S8 may be concave with respect to the image side on the optical axis. The fourth lens 140 may have a concave shape on both surfaces. The seventh surface S7 may be an aspherical surface, and the seventh surface S7 may be an aspherical surface.

The fifth lens 150 may have positive (+) refractive power. The ninth surface S9 of the fifth lens 150 may be concave with respect to the object side in the optical axis, and the tenth surface S10 may be convex in the optical axis with respect to the image side. The fifth lens 150 may have a meniscus shape that is convex on the image side. The ninth surface S9 may be an aspherical surface, and the tenth surface S10 may be an aspherical surface.

The sixth lens 160 may have positive (+) refractive power. The eleventh surface S11 of the sixth lens 160 may be concave with respect to the object side on the optical axis, and the twelfth surface S12 may be convex with respect to the image side on the optical axis. The sixth lens 150 may have a convex meniscus shape on the image side. The eleventh surface S11 may be an aspherical surface, and the twelfth surface S12 may be an aspherical surface.

Additionally, referring to FIGS. 1 and 2, the camera module operates in infinity mode to obtain information about a subject located at an infinite distance. In detail, the driving member may operate in an infinite mode by controlling the position of at least one lens group among a plurality of lens groups.

For example, when the camera module operates in infinity mode, the first lens group G1 and the third lens group G3 may be fixed, and the second lens group G2 may be moved by the driving force of the driving member. In detail, in the infinity mode, the second lens group G2 may be placed at the first position. At this time, if the initial position of the second lens group G2 is not the first position corresponding to the infinity mode, the second lens group G2 may be moved to the first position. That is, the second lens group G2 is spaced apart from the first lens group G1 at a first distance d1 by the driving force of the driving member, and may be disposed in an area spaced apart from the third lens group G3 by a second distance d2. Here, the first distance d1 refers to the center distance on the optical axis between the third lens 130 and the fourth lens 140, the second distance d2 may mean the center distance on the optical axis between the fifth lens 150 and the sixth lens 160.

Differently, when the initial position of the second lens group G2 is the first position, the second lens group G2 can be placed at the first position without any additional movement. Accordingly, the second lens group G2 may be disposed in an area spaced apart from the first lens group G1 by a first distance d1 and spaced apart from the third lens group G3 by a second distance d2.

When the camera module operates in infinity mode, the optical system 1000 may have a first TTL TTL1 defined as a TTL value and a first BFL BFL1 defined as a BFL value at the first position, and may have a first EFL EFL1 defined as an effective focal length (EFL).

Additionally, the optical system 1000 may have excellent aberration characteristics as shown in FIG. 6. In detail, FIG. 6 is a graph of the aberration characteristics of the optical system 1000 operating in the first mode (infinity mode), and is a graph measuring longitudinal spherical aberration, astigmatic field curves, distortion. In FIG. 6, the X-axis may represent focal length (mm) and distortion (%), and the Y-axis may represent the height of the image. In addition, the graph for spherical surface aberration is a graph for light in the wavelength bands of about 435 nm, about 486 nm, about 546 nm, about 587 nm, and about 656 nm, and the graph for astigmatic field curves and distortion is a graph for light in the 546 nm wavelength band.

TABLE 3

| | | | Lens | | | |
|---|---|---|---|---|---|---|
| | | | thickness | | | |
| | | Radius of | and lens | | | Size of clear |
| | | curvature | distance | Refractive | Abbe's | aperture |
| | Surface | (mm) | (mm) | index | Number | (mm) |
| First lens | First surface | 6.6285 | 1.4028 | 1.5348 | 55.7000 | 5.4 |
| | Second surface | −25.0476 | 0.26160 | | | 5.0767 |
| Second lens | Third surface | −12.8346 | 0.3700 | 1.5880 | 28.3000 | 3.7571 |
| | Fourth surface | 3.6092 | 0.1000 | | | 3.8297 |
| Third lens | Fifth surface | 3.1945 | 1.2989 | 1.5348 | 55.7000 | 3.889 |
| | Sixth surface | −4.2649 | | | | 3.8293 |
| Fourth lens | Seventh surface | −11.8589 | 0.3700 | 1.5348 | 55.7000 | 3.0369 |
| | Eighth surface | 3.1218 | 0.6068 | | | 2.613 |
| Fifth lens | Ninth surface | −29.7485 | 2.1543 | 1.6610 | 20.4000 | 2.56 |
| | Tenth surface | −9.1599 | | | | 3.7214 |
| Sixth lens | Eleventh surface | −100.000 | 0.5000 | 1.5348 | 55.7000 | 5.8919 |
| | Twelfth surface | −100.000 | | | | 6.0166 |

TABLE 4

| | |
|---|---|
| TTL2 | 17.2000 |
| BFL2 | 0.7900 |
| EFL2 | 10.6196 |
| ImgH | 6.4280 |
| Third distance (d3) | 2.1087 |
| Fourth distance (d4) | 4.4726 |

Table 3 provides lens information when the camera module operates in the second mode, which is the short-distance mode. In detail, Table 3 shows the radius of curvature, thickness of each lens, center distance on the optical axis between each lens, refractive index, Abbe's Number, size of clear aperture of the first to sixth lenses 110, 120, 130, 140, 150, and 160 in the short-distance mode.

Additionally, Table 4 shows data on the size of the image sensor unit, TTL when operating in infinity mode, BFL BFL1, EFL EFL1, and the distance between the moving group and the fixed group.

Referring to FIGS. 3 and 4, the camera module operates in a short-distance mode and may obtain information about a subject located at a short distance. When the subject is located at a short distance, the driving member may operate in a short-distance mode by controlling the position of at least one lens group among a plurality of lens groups.

For example, when the camera module operates in short-distance mode, the first lens group G1 may be fixed, and the second lens group G2 may be moved by the driving force of the driving member. In detail, in the short-distance mode, the second lens group G2 may be disposed at a second position. At this time, if the initial position of the second lens group G2 is not the second position corresponding to the short-distance mode, the second lens group G2 may be moved to the second position. That is, the second lens group G2 may be spaced apart from the first lens group G1 at a third distance d3 and may be placed in an area separated from the third lens group G3 at a fourth distance d4 by the driving force of the driving member. Here, the third distance d3 refers to the center distance between the third lens 130 and the fourth lens 140, the fourth distance d4 may mean the center distance between the fifth lens 150 and the sixth lens 160.

Differently, when the initial position of the second lens group G2 is the second position, the second lens group G2 may be placed in the second position without any additional movement. Accordingly, the second lens group G2 may be spaced apart from the first lens group G1 at a third distance d3 and may be disposed in an area spaced apart from the third lens group G3 at a fourth distance d4.

That is, when the camera module operates in short-distance mode, the distance between the first lens group G1 and the second lens group G2 compared to the infinity mode, for example, the gap between the third lens 130 and the fourth lens 140 and the distance between the second lens group G2 and the third lens group G3, for example, the distance between the fifth lens 150 and the sixth lens 160 may change.

In addition, when the camera module operates in short-distance mode, the optical system 1000 may have a second TTL TTL2 defined as a TTL value at the second position, may have a second BFL BFL2 defined by the BFL value, may have a second EFL EFL2, defined as effective focal length (EFL).

At this time, the second TTL TTL2 may be the same as the first TTL TTL1. That is, as the first lens group G1 is fixed, the first TTL TTL1 and the second TTL may be the same. Additionally, the second EFL may be larger than the first EFL, and the second BFL BFL2 and the first BFL BFL1 may be the same.

Additionally, the optical system 1000 may have excellent aberration characteristics as shown in FIG. 7. In detail, FIG. 7 is a graph of the aberration characteristics of the optical system 1000 operating in the second mode (short-distance mode), and is a graph measuring longitudinal spherical aberration, astigmatic field curves, distortion. In FIG. 7, the X-axis may represent focal length (mm) and distortion (%), and the Y-axis may represent the height of the image. In addition, the graph for spherical surface aberration is a graph for light in the wavelength bands of about 435 nm, about 486 nm, about 546 nm, about 587 nm, and about 656 nm, and the graph for astigmatic field curves and distortion is a graph for light in the 546 nm wavelength band.

In other words, the camera module according to the embodiment may be converted to infinity mode or short-distance mode depending on the distance from the subject. At this time, the second lens group G2 may move to the first position or the second position depending on the distance from the subject. For example, the second lens group G2 may move from the first position to the second position, or from the second position to the first position.

At this time, the movement distance md1 of the second lens group G2 may be smaller than the total TTL value of the optical system 1000, for example, the first TTL TTL1 and the second TTL TTL2. Additionally, the moving distance md1 of the second lens group G2 may be smaller than the first BFL BFL1 and the second BFL BFL2.

In addition, the moving distance md1 of the second lens group G2 may be smaller than the diagonal length (ImgH) of the image sensor 300, and may be smaller than the clear aperture size (CA_Sa) of the lens having the largest clear aperture among the plurality of lens surfaces. For example, the moving distance md1 of the second lens group G2 may be about 1 mm or more. In detail, the moving distance of the second lens group G2 may be about 1.8 mm. Here, the moving distance md1 may mean the difference between the third distance d2 and the first distance d1 or the difference between the fourth distance d4 and the second distance d2.

Additionally, the brightness value in the first mode and the second mode may be 80% or more of the F-number.

Hereinafter, the optical system and optical module according to the second embodiment will be described in more detail. In detail, in the optical system 1000 and the optical module 2000, the plurality of lenses 100 when the first lens group G1 and the third lens group G3 are fixed and the second lens group G2 is provided to be movable will now be described in detail.

TABLE 5

| | | | Lens | | | |
|---|---|---|---|---|---|---|
| | | | thickness | | | |
| | | Radius of | and lens | | | Size of clear |
| | | curvature | distance | Refractive | Abbe's | aperture |
| | Surface | (mm) | (mm) | index | Number | (mm) |
| First lens | First surface | 6.5975 | 2.1000 | 1.5348 | 56.0000 | 5.54 |
| | Second surface | −18.2699 | 1.9820 | | | 4.62 |
| Second lens | Third surface | −7.4895 | 0.3000 | 1.6150 | 26.0000 | 3.8534 |
| | Fourth surface | 6.8696 | 0.1000 | | | 3.8706 |
| Third lens | Fifth surface | 4.7704 | 1.2320 | 1.5348 | 56.0000 | 3.9 |
| | Sixth surface | −3.9547 | 0.4545 | | | 3.9 |
| Fourth lens | Seventh surface | −4.3133 | 0.3000 | 1.5445 | 56.0000 | 3.18 |
| | Eighth surface | 4.7635 | 0.9103 | | | 2.908 |
| Fifth lens | Ninth surface | −245.0326 | 1.4212 | 1.6150 | 26.0000 | 2.78 |
| | Tenth surface | −7.5734 | 7.3868 | | | 3.6 |
| Sixth lens | Eleventh surface | −100.000 | 0.4000 | 1.5348 | 56.0000 | 6.0372 |
| | Twelfth surface | −100.000 | | | | 6.1273 |

TABLE 6

| | |
|---|---|
| TTL1 | 17.1000 |
| BFL1 | 8.7868 |
| EFL1 | 17.1000 |
| ImgH | 6.4280 |
| First distance (d1) | 0.4245 |
| Second distance (d2) | 7.3868 |

Table 5 provides lens information when the camera module operates in the first mode, which is the infinity mode. In detail, Table 1 shows the radius of curvature, thickness of each lens, center distance on the optical axis between each lens, refractive index, Abbe's Number, size of clear aperture of the first to sixth lenses 110, 120, 130, 140, 150, and 160 in the infinity mode.

Additionally, Table 6 shows data on the size of the image sensor unit, TTL when operating in infinity mode, BFL BFL1, EFL EFL1, and the gap between the moving group and the fixed group.

Referring to Table 5, the first lens 110 of the optical system 1000 according to the embodiment may have positive (+) refractive power. The first surface S1 of the first lens 110 may be convex with respect to the object side on the optical axis, and the second surface S2 may be convex with respect to the image side on the optical axis. The first lens 110 may have a convex shape on both surfaces. The first surface S1 may be an aspherical surface, and the second surface S2 may be an aspherical surface.

The second lens 120 may have negative (−) refractive power. The third surface S3 of the second lens 120 may be concave in the optical axis with respect to the object side, and the fourth surface S4 may be concave in the optical axis with respect to the image side. The second lens 120 may have a concave shape on both surfaces. The third surface S3 may be an aspherical surface, and the fourth surface S4 may be an aspherical surface.

The third lens 130 may have positive (+) refractive power. The fifth surface S5 of the third lens 130 may be convex with respect to the object side on the optical axis, and the sixth surface S6 may be convex with respect to the image side on the optical axis. The third lens 130 may have a convex shape on both surfaces. The fifth surface S5 may be an aspherical surface, and the sixth surface S6 may be an aspherical surface.

The fourth lens 140 may have negative (−) refractive power. The seventh surface S7 of the fourth lens 140 may be concave with respect to the object side on the optical axis, and the eighth surface S8 may be concave with respect to the image side on the optical axis. The fourth lens 140 may have a concave shape on both surfaces. The seventh surface S7 may be an aspherical surface, and the seventh surface S7 may be an aspherical surface.

The fifth lens 150 may have positive (+) refractive power. The ninth surface S9 of the fifth lens 150 may be concave with respect to the object side in the optical axis, and the tenth surface S10 may be convex in the optical axis with respect to the image side. The fifth lens 150 may have a meniscus shape that is convex on the image side. The ninth surface S9 may be an aspherical surface, and the tenth surface S10 may be an aspherical surface.

The sixth lens 160 may have positive (+) refractive power. The eleventh surface S11 of the sixth lens 160 may be concave with respect to the object side on the optical axis, and the twelfth surface 512 may be convex with respect to the image side on the optical axis. The sixth lens 150 may have a convex meniscus shape on the image side. The eleventh surface S11 may be an aspherical surface, and the twelfth surface S12 may be an aspherical surface.

Additionally, the optical system 1000 may have excellent aberration characteristics as shown in FIG. 10. In detail, FIG. 10 is a graph of the aberration characteristics of the optical system 1000 operating in the first mode (infinity mode), and is a graph measuring longitudinal spherical aberration, astigmatic field curves, distortion. In FIG. 10, the X-axis may represent focal length (mm) and distortion (%), and the Y-axis may represent the height of the image. In addition, the graph for spherical surface aberration is a graph for light in the wavelength bands of about 435 nm, about 486 nm, about 546 nm, about 587 nm, and about 656 nm, and the graph for astigmatic field curves and distortion is a graph for light in the 546 nm wavelength band.

TABLE 7

| | | | Lens | | | |
|---|---|---|---|---|---|---|
| | | | thickness | | | |
| | | Radius of | and lens | | | Size of clear |
| | | curvature | distance | Refractive | Abbe's | aperture |
| | Surface | (mm) | (mm) | index | Number | (mm) |
| First lens | First surface | 6.5975 | 2.1000 | 1.5348 | 56.0000 | 5.54 |
| | Second surface | −18.2699 | 1.9820 | | | 4.62 |
| Second lens | Third surface | −7.4895 | 0.3000 | 1.6150 | 26.0000 | 3.8534 |
| | Fourth surface | 6.8696 | 0.1000 | | | 3.8706 |
| Third lens | Fifth surface | 4.7704 | 1.2320 | 1.5348 | 56.0000 | 3.9 |
| | Sixth surface | −3.9547 | 0.4545 | | | 3.9 |
| Fourth lens | Seventh surface | −4.3133 | 0.3000 | 1.5445 | 56.0000 | 3.18 |
| | Eighth surface | 4.7635 | 0.9103 | | | 2.908 |
| Fifth lens | Ninth surface | −245.0326 | 1.4212 | 1.6150 | 26.0000 | 2.78 |
| | Tenth surface | −7.5734 | 7.3868 | | | 3.6 |
| Sixth lens | Eleventh surface | −100.000 | 0.4000 | 1.5348 | 56.0000 | 6.0372 |
| | Twelfth surface | −100.000 | | | | 6.1273 |

TABLE 8

| | |
|---|---|
| TTL2 | 17.1000 |
| BFL2 | 8.7868 |
| EFL2 | 11.0244 |
| ImgH | 6.4280 |
| Third distance (d3) | 2.114972 |
| Fourth distance (d4) | 5.696421 |

Table 7 provides lens information when the camera module operates in the second mode, which is short-distance mode. In detail, Table 7 shows the radius of curvature, thickness of each lens, center distance on the optical axis between each lens, refractive index, Abbe's Number, size of clear aperture of the first to sixth lenses 110, 120, 130, 140, 150, and 160 in the infinity mode.

Additionally, Table 8 shows data on the size of the image sensor unit, TTL when operating in infinity mode, BFL BFL1, EFL EFL1, and the distance between the moving group and the fixed group.

The optical system 1000 may have excellent aberration characteristics as shown in FIG. 11. In detail, FIG. 11 is a graph of the aberration characteristics of the optical system 1000 operating in the second mode (short-distance mode), and is a graph measuring longitudinal spherical aberration, astigmatic field curves, distortion. In FIG. 11, the X-axis may represent focal length (mm) and distortion (%), and the Y-axis may represent the height of the image. In addition, the graph for spherical surface aberration is a graph for light in the wavelength bands of about 435 nm, about 486 nm, about 546 nm, about 587 nm, and about 656 nm, and the graph for astigmatic field curves and distortion is a graph for light in the 546 nm wavelength band.

In other words, the camera module according to the embodiment may be converted to infinite mode or short-distance mode depending on the distance from the subject. At this time, the second lens group G2 may move to the first position or the second position depending on the distance from the subject. For example, the second lens group G2 may move from the first position to the second position, or from the second position to the first position.

At this time, the movement distance md1 of the second lens group G2 may be smaller than the total TTL value of the optical system 1000, for example, the first TTL TTL1 and the second TTL TTL2. Additionally, the moving distance md1 of the second lens group G2 may be smaller than the first BFL BFL1 and the second BFL BFL2.

In addition, the moving distance md1 of the second lens group G2 may be smaller than the diagonal length (ImgH) of the image sensor 300, and may be smaller than the clear aperture size (CA_Sa) of the lens having the largest clear aperture among the plurality of lens surfaces. For example, the moving distance md1 of the second lens group G2 may be about 1 mm or more. In detail, the moving distance of the second lens group G2 may be about 1.8 mm. Here, the moving distance md1 may mean the difference between the third distance d2 and the first distance d1 or the difference between the fourth distance d4 and the second distance d2.

Additionally, the brightness value in the first mode and the second mode may be 80% or more of the F-number.

TABLE 9

| Surface# | 1 | 2 | 3 | 4 | 5 | 6 | 7 | 8 |
|---|---|---|---|---|---|---|---|---|
| k = | −1.396620492 | 17.38603977 | 14.15701402 | −3.600048925 | 0.973147017 | −7.720865274 | 11.72001004 | −7.828154572 |
| A4 = | 0.000430534 | 0.000856998 | −0.000757242 | 0.003852822 | −0.01228791 | −0.011357945 | 0.0033120424 | 0.060218225 |
| A6 = | 7.17E−05 | 0.00014968 | 0.000356179 | −0.001415838 | −0.001723982 | 0.001944989 | −0.011397934 | −0.020024501 |
| A8 = | 1.42E−05 | 2.43E−05 | −1.57E−04 | −304E−05 | −7.31E−05 | −5.43E−04 | 2.88E−05 | 7.43E−03 |
| A10 = | −8.66E−07 | −5.40E−06 | 2.31E−05 | −3.95E−06 | 2.85E−05 | 3.84E−07 | 2.93E−05 | −2.05E−03 |
| A12 = | 1.24E−07 | 1.16E−06 | −1.38E−05 | 6.81E−07 | −8.54E−08 | 5.92E−05 | −1.01E−04 | 4.05E−04 |
| A14 = | 1.07E−08 | 1.35E−07 | −7.97E−07 | 4.28E−07 | −3.17E−06 | −8.90E−06 | −3.10E−05 | −1.32E−04 |
| A16 = | −1.08E−09 | 1.95E−08 | 3.32E−06 | −1.01E−06 | 6.42E−07 | −3.74E−06 | 4.89E−06 | 1.02E−04 |
| A18 = | 4.74E−11 | −2.17E−09 | −9.96E−07 | 1.44E−07 | −3.81E−07 | 1.17E−06 | 6.05E−06 | −3.67E−05 |
| A20 = | 6.21E−12 | 1.33E−10 | 9.19E−08 | 9.84E−09 | 6.28E−08 | −8.51E−08 | −1.27E−06 | 6.43E−08 |

| Surface# | 9 | 10 | 11 | 12 |
|---|---|---|---|---|
| k = | −63.33670388 | −63.54490696 | — | — |
| A4 = | −0.013153937 | −0.017486472 | — | — |
| A6 = | −0.001588474 | 0.003308073 | — | — |
| A8 = | 9.95E−04 | −1.32E−03 | — | — |
| A10 = | −7.23E−04 | 4.62E−04 | — | — |
| A12 = | −6.76E−05 | −2.28E−04 | — | — |
| A14 = | −1.35E−04 | 1.13E−04 | — | — |
| A16 = | 2.40E−04 | −3.61E−05 | — | — |
| A18 = | −8.2E−05 | 6.06E−06 | — | — |
| A20 = | 1.44E−06 | −4.06E−07 | — | — |

TABLE 10

| Surface# | 1 | 2 | 3 | 4 | 5 | 6 | 7 | 8 |
|---|---|---|---|---|---|---|---|---|
| k = | −0.159805028 | −57.33390889 | −23.3350635 | 8.168154991 | −4.137505117 | −6.173738764 | −24.07288368 | 5.236599822 |
| 4 = | 0.000177917 | 0.000296648 | −0.002454073 | 0.001590455 | 0.002194885 | 0.010791333 | 0.020361515 | 0.033601749 |
| A6 = | 4.29E−05 | 2.09E−04 | 3.60E−04 | −2.61E−03 | −2.47E−03 | 6.44E−04 | −7.83E−03 | −2.09E−02 |
| A8 = | 7.47E−06 | 2.34E−05 | −3.94E−04 | −1.36E−04 | −3.61E−05 | −1.70E−04 | 1.99E−03 | 6.30E−03 |
| A10 = | 5.97E−07 | −3.17E−06 | 2.60E−05 | −8.87E−05 | 7.86E−05 | 1.34E−05 | −4.81E−04 | −1.67E−03 |
| A12 = | 1.31E−08 | 6.75E−07 | −9.69E−06 | 8.32E−06 | −1.02E−06 | 3.49E−05 | 2.40E−04 | 2.89E−05 |
| A14 = | −1.35E−08 | −1.87E−07 | 1.01E−06 | 7.53E−06 | −7.43E−06 | −9.05E−06 | −8.42E−05 | 7.16E−05 |
| A16 = | −5.08E−10 | 2.56E−08 | 3.14E−06 | 6.27E−07 | 1.69E−06 | −2.33E−06 | 7.41E−06 | −2.67E−05 |
| A18 = | 3.78E−10 | 1.82E−11 | −9.50E−07 | −3.94E−07 | 3.17E−07 | 1.12E−06 | 2.10E−06 | −5.71E−07 |
| A20 = | −2.10E−11 | −1.06E−10 | 7.50E−08 | 3.54E−09 | −8.45E−08 | −1.11E−07 | −3.80E−07 | 6.49E−08 |

| Surface# | 9 | 10 | 11 | 12 |
|---|---|---|---|---|
| k = | −90 | −25.11031424 | — | — |
| A4 = | −0.023927354 | −0.019627623 | — | — |
| A6 = | −4.03E−03 | 6.96E−04 | — | — |
| A8 = | 6.00E−03 | −2.21E−04 | — | — |
| A10 = | −6.88E−03 | 9.88E−05 | — | — |
| A12 = | 3.12E−03 | −1.92E−04 | — | — |
| A14 = | −6.91E−4 | 1.17E−04 | — | — |
| A16 = | 6.41E−05 | −3.66E−05 | — | — |
| A18 = | −2.05E−05 | 5.90E−06 | — | — |
| A20 = | 1.44E−06 | −3.99E−07 | — | — |

TABLE 11

| | First embodiment | Second embodiment |
|---|---|---|
| md1 | 1.75 | 1.69 |
| EFL(EFL_1/EFL_2) | 17.1000/10.6196 | 17.1000/11.0244 |
| f1 | 9.9122 | 9.2990 |
| f2 | −4.7118 | −5.7277 |
| f3 | 3.6149 | 4.2347 |
| f4 | 4.5617 | −4.0918 |
| f5 | 18.9983 | 12.5637 |
| f6 | 106566.7727 | 133208.0000 |
| f34(f34_1/f34_2) | 8.2123687/4.388 | 22.950716/7.085831 |
| f56(f56_1/f56_2) | 19.0292/19.0289 | 12.5808/12.58062 |
| f234(f234_1/f234_2) | −7.93879/−11.2149 | −6.083/−7.81789 |
| f345(f345_1/f345_2) | 6.979879/4.7563975 | 10.0348/6.641186 |
| f1234(f1234_1/f1234_2) | 27.2926/10.719 | 53.424984/12.4057 |
| f2345(f2345_1/f2345_2) | −17.71/−30.0825193 | −17.528/−26.3102 |
| f456(f456_1/f456_2) | −7.2420/−7.2419 | −7.8510/−7.8509 |
| f3456(f3456_1/f3456_2) | 6.99228/4.764969 | 10.048877/6.65 |
| f23456(f23456_1/f23456_2) | −17.7462/−30.1453 | −17.55699/−26.354 |
| CA_L1S1 | 5.4 | 5.54 |
| CA_L1S2 | 5.0767 | 4.62 |
| CA_L6S1 | 5.8919 | 6.0372 |
| CA_L6S2 | 6.0166 | 6.1273 |
| P1 | 0.1009 | 0.1075 |
| P2 | −0.2122 | −0.1746 |
| P3 | 0.2766 | 0.2361 |
| P4 | −0.2192 | −0.2444 |
| P5 | 0.0526 | 0.0796 |
| P6 | 0.000001 | 0.000001 |
| TTL | 17.2000 | 17.5570 |
| ImgH | 6.4280 | 6.4280 |

TABLE12

| | First embodiment | Second embodiment |
|---|---|---|
| Equation1 | Satisfied | Satisfied |
| Equation 2 | Satisfied | Satisfied |
| Equation 3 | Satisfied | Satisfied |
| Equation 4 | Satisfied | Satisfied |
| Equation 5 | 0.62 | 0.65 |
| Equation 6 | 1.16 | 2.01 |
| Equation 7 | 0.62 | 0.64 |
| Equation 8 | 0.44 | 0.50 |
| Equation 9 | 0.91 | 0.98 |
| Equation10 | 1.58 | 2.78 |
| Equation11 | 0.36 | 0.43 |
| Equation12 | 0.62 | 0.65 |
| Equation13 | 0.91 | 0.98 |
| Equation14 | 0.37 | 0.43 |
| Equation15 | Satisfied | Satisfied |
| Equation16 | 5.87 | 4.98 |
| Equation17 | 0.72 | 0.77 |
| Equation18 | 3.50 | 3.38 |
| Equation19 | 1.61 | 1.55 |
| Equation 20 | Satisfied | Satisfied |
| Equation 21 | Satisfied | Satisfied |
| Equation 22 | 9.82 | 10.38 |
| Equation 23 | 0.27 | 0.26 |

Table 9 shows the value of the aspherical surface coefficient of each lens surface in the optical system 1000 according to the first embodiment, Table 10 shows the value of the aspherical surface coefficient of each lens surface in the optical system 1000 according to the second embodiment, Table 11 shows the result values for the items of the above equations in the optical system, optical module, and camera module according to the embodiment, Table 12 shows result values for Equations 1 to 23 of the optical system 1000 and the optical module 2000 according to embodiments.

Referring to Table 12, it may be seen that the optical system 1000, the optical module 2000, and the camera module according to the embodiments satisfy at least one of Equations 1 to 23. In detail, it can be seen that the optical system 1000, the optical module 2000, and the camera module according to the embodiments all satisfy Equations 1 to 23 above.

Accordingly, the embodiment has improved optical characteristics and may prevent or minimize deterioration of peripheral image quality. Additionally, the embodiment may provide an autofocus (AF) function for subjects located at various distances using the optical system 1000 and optical module 2000 having set shapes, focal lengths, spacing, etc. In detail, the embodiment can provide an autofocus (AF) function for subjects located at infinity or short-distance using one camera module.

In particular, the embodiment may control the effective focal length (EFL) by moving at least one lens group and minimize the moving distance of the moving lens group. For example, the moving distance md1 of the second lens group G2 according to the embodiment may be 1.8 mm, which is the difference between the second distance d2 and the first distance d1. That is, the second lens group G2 can move 1.8 mm from infinity to close focus (30 mm).

Accordingly, the optical system 1000 according to the embodiment may significantly reduce the moving distance of the lens group when changing focus from infinity to short-distance, thereby minimizing power consumption required when moving the lens group. Additionally, by minimizing the moving distance of the lens group, the amount of curvature that occurs according to the moving distance of the moving lens group may be minimized. Accordingly, the optical system according to the embodiment may have improved electrical and optical characteristics.

Additionally, the embodiment may have a constant TTL value regardless of the distance to the subject in the range of infinity to short-distance. Accordingly, the optical system 1000 and the camera module including it may be provided in a slimmer structure.

Additionally, at least one lens in the optical system 1000 may have a non-circular shape, for example, a D-cut shape. Accordingly, the optical system 1000 may be implemented in a small size, has improved optical performance, and may be provided in a compact manner compared to an optical system consisting of only a circular shape.

Additionally, the optical system 1000 may include a plurality of lenses and an optical path changing member (not shown). Accordingly, the optical system 1000 may be applied to a folded camera that may have a thinner thickness, and a device including the camera may be manufactured with a thinner thickness.

FIG. 13 is a diagram showing a camera module according to an embodiment applied to a mobile device.

Referring to FIG. 13, the mobile device 1 may include a camera module 10 provided on the rear.

The camera module 10 may include an image capturing function. Additionally, the camera module 10 may include at least one of an auto focus, zoom function, and OIS function.

The camera module 10 may process image frames of still images or videos obtained by the image sensor 300 in shooting mode or video call mode. The processed image frame may be displayed on a display unit (not shown) of the mobile device 1 and may be stored in a memory (not shown). In addition, although not shown in the drawing, the camera module may be further disposed on the front of the mobile device 1.

For example, the camera module 10 may include a first camera module 10A and a second camera module 10B. At this time, at least one of the first camera module 10A or the second camera module 10B may include the optical system 1000 described above. Accordingly, the camera module 10 may have improved optical characteristics and may provide an autofocus (AF) function for subjects located at a short distance from infinity to 40 mm or less. In addition, when the optical system 1000 provides the above function by moving at least one lens group, the amount of movement of the lens group may be minimized, which allows operation at low power and minimizes the amount of curvature that occurs due to movement. Additionally, the camera module may be provided more compactly by using the optical system 1000 having a slim structure.

The mobile device 1 may further include an autofocus device 31. The autofocus device 31 may include an autofocus function using a laser. The autofocus device 31 may be mainly used in conditions where the autofocus function using the image of the camera module 10 is deteriorated, for example, at a distance of 10 m or less or in a dark environment. The autofocus device 31 may include a light emitting unit including a vertical cavity surface emitting laser (VCSEL) semiconductor device, and a light receiving unit such as a photo diode that converts light energy into electrical energy.

In addition, the mobile device 1 may further include a flash module 33. The flash module 33 may include a light emitting device inside that emits light. The flash module 33 may be operated by operating a camera of a mobile device or by user control.

The features, structures, effects, etc. described in the embodiments above are included in at least one embodiment of the present invention and are not necessarily limited to only one embodiment. Furthermore, the features, structures, effects, etc. illustrated in each embodiment may be combined or modified and implemented on other embodiments by a person with ordinary knowledge in the field to which the embodiments belong. Therefore, contents related to such combinations and modifications should be construed as being included in the scope of the present invention.

In addition, although the above description focuses on the embodiment, this is only an example and does not limit the present invention, and those of ordinary skill in the field to which the present invention pertains will recognize that various modifications and applications not exemplified above are possible without departing from the essential characteristics of this embodiment. For example, each component specifically shown in the embodiment can be modified and implemented. And these variations and differences in application should be construed as being included in the scope of the present invention as defined in the appended claims.

1. An optical system comprising:
a first lens group, a second lens group, and a third lens group sequentially arranged along an optical axis from an object side to an image side and wherein each of the first to third lens groups includes at least one lens, and wherein each lens has an object side and an image side;
wherein a refractive power sign of the first lens group and a refractive power sign of the second lens group are opposite to each other, and
wherein the first lens group, the second lens group, and the third lens group satisfy Equation 1 below:
$$0 \text{.6} < \vert f\_ 1 / f\_ 23 \vert < 1. 4 \qquad [ Equation 1 ]$$
(In Equation 1, f_1 is a focal length of the first lens group, f_23 is a combined focal length of the second lens group and the third lens group).

2. The optical system according to claim 1, wherein the first lens group includes a first lens, a second lens, and a third lens sequentially arranged along the optical axis in a direction from the object side to the image side,
wherein the second lens group includes a fourth lens and a fifth lens sequentially arranged along the optical axis in the direction from the object side to the image side, and
wherein the third lens group includes a sixth lens sequentially arranged along the optical axis in the direction from the object side to the image side.

3. The optical system according to claim 1, wherein the first lens group has positive (+) refractive power, and
wherein the second lens group has negative (−) refractive power.

4. The optical system according to claim 1, wherein the first lens group includes at least one lens having a non-circular shape.

5. The optical system according to claim 1, wherein the third lens group includes at least one lens having a spherical surface shape.

6. The optical system according to claim 1, wherein the optical system satisfies Equation 2 and Equation 3 below:
$$\begin{matrix}CA\_L6S1 > CA\_L1S1 , \\ CA\_L6S1 > CA\_L1S2\end{matrix} \qquad [ Equation 2 ]$$
(In Equation 2, CA_L6S1 means a size of a maximum clear aperture (clear aperture; CA) on the object side of a sixth lens, CA_L1S1 means a size of a maximum clear aperture on the object side of a first lens, CA_L1 S2 means a size of a maximum clear aperture on the image side of the first lens);
$$\begin{matrix}CA\_L6S2 > CA\_L1S1 , \\ CA\_L6S2 > CA\_L1S2\end{matrix} \qquad [ Equation 3 ]$$
(In Equation 3, CA_L6S2 means a size of a maximum clear aperture on the image side of the sixth lens, CA_L1S1 means the size of the maximum clear aperture on the object side of the first lens, CA_L1S2 means the size of the maximum clear aperture on the image side of the first lens).

7. The optical system according to claim 1, wherein the optical system satisfies Equation 4 below:
$$0 < \vert P 6 \vert < \vert P 1 \vert , \vert P 2 \vert , \vert P 3 \vert , \vert P 4 \vert , \vert P 5 \vert \qquad [ Equation 4 ]$$
(In Equation 4, P1, P2, P3, P4, P5, and P6 mean refractive power of a first lens, second lens, third lens, fourth lens, fifth lens, and sixth lens, respectively).

8. The optical system according to claim 1, wherein the optical system satisfies Equation 22 below:
$$8 < TTL / md 1 < 12 \qquad [ Equation 22 ]$$
(In Equation 22, md1 means a moving distance of the second lens group G2 when changing from infinity mode (first mode) to short-distance mode (second mode) or from short-distance mode (second mode) to infinity mode (first mode), Total track length (TTL) refers to a distance in a direction of the optical axis OA from a vertex of the object side of the lens closest to an object among a plurality of lenses to an image surface of an image sensor unit).

9. An optical module comprising:
an optical system; and
an image sensor unit where light passing through the optical system is incident,
wherein a first lens group, a second lens group, and a third lens group are sequentially arranged along an optical axis from an object side to an image side and each lens group includes at least one lens, and wherein each lens has an object side and an image side;
wherein a refractive power sign of the first lens group and a refractive power sign of the second lens group are opposite to each other, and
wherein the first lens group, the second lens group, and the third lens group satisfy Equation 4 below:
$$0 < \vert P 6 \vert < \vert P 1 \vert , \vert P 2 \vert , \vert P 3 \vert , \vert P 4 \vert , \vert P 5 \vert \qquad [ Equation 4 ]$$
(In Equation 4, P1, P2, P3, P4, P5, and P6 refer to refractive power of a first lens, second lens, third lens, fourth lens, fifth lens, and sixth lens, respectively).

10. The optical module according to claim 9, wherein the optical module satisfies Equation 23 below:
$$0.1 < md 1 / ImgH < 0.3 \qquad [ Equation 23 ]$$
(In Equation 23, md1 means a moving distance of the second lens group G2 when changing from infinity mode (first mode) to short-distance mode (second mode) or from short-distance mode (second mode) to infinity mode (first mode), ImgH refers to a vertical distance of the optical axis OA from a 0 field area of the image sensor unit to a 1.0 field area of the image sensor unit, that is, the ImgH refers to a diagonal length of an effective area of the image sensor unit).

11. The optical system according to claim 1, wherein the optical system satisfies Equation 5 below:
$$0.6 < \vert EFL\_ 2 / f 6 \vert / \vert EFL\_ 1 / f 6 \vert < 0.7 \qquad [ Equation 5 ]$$
(In Equation 5, EFL_1 is an effective focal length at a maximum moving distance of the second lens group in first mode, EFL_2 is an effective focal length at a maximum moving distance of the second lens group in second mode, and f6 is a focal length of a sixth lens).

12. The optical system according to claim 1, wherein the optical system satisfies Equation 6 below:
$$1. < \vert EFL\_ 2 / f34\_ 1 \vert / \vert EFL\_ 1 / f34\_ 2 \vert < 2.5 \qquad [ Equation 6 ]$$
(In Equation 6, EFL_1 is an effective focal length at a maximum moving distance of the second lens group in first mode, EFL_2 is an effective focal length at a maximum moving distance of the second lens group in second mode, f34_1 is a complex focal length of a third lens and a fourth lens at the maximum moving distance of the second lens group in first mode, f34_2 means a combined focal length of the third lens and the fourth lens at the maximum moving distance of the second lens group in second mode).

13. The optical system according to claim 1, wherein the optical system satisfies Equation 7 below:
$$0.6 < \vert EFL\_ 2 / f56\_ 2 \vert / \vert EFL\_ 1 / f56\_ 1 \vert < 0.7 \qquad [ Equation 7 ]$$
(In Equation 7, EFL_1 is an effective focal length at a maximum moving distance of the second lens group in first mode, EFL_2 is an effective focal length at a maximum moving distance of the second lens group in second mode, f56_1 is a complex focal length of a fifth lens and a sixth lens at the maximum moving distance of the second lens group in first mode, f56_2 means a complex focal length of the fifth lens and the sixth lens at the maximum moving distance of the second lens group in second mode).

14. The optical module according to claim 9, wherein the first lens group, the second lens group, and the third lens group satisfy Equation 1 below:
$$0.6 < \vert f\_ 1 / f\_ 23 \vert < 1.4 \qquad [ Equation 1 ]$$
(In Equation 1, f_1 is a focal length of the first lens group, f_23 is a combined focal length of the second lens group and the third lens group).

15. The optical module according to claim 9, wherein the first lens group includes a first lens, a second lens, and a third lens sequentially arranged along the optical axis in a direction from the object side to the image side,
wherein the second lens group includes a fourth lens and a fifth lens sequentially arranged along the optical axis in the direction from the object side to the image side,
wherein the third lens group includes a sixth lens sequentially arranged along the optical axis in the direction from the object side to the image side, and
wherein the optical module satisfies Equation 2 and Equation 3 below:
$$CA\_L6S1 > CA\_L1S1 , \qquad [ Equation 2 ]$$
$$CA\_L6S1 > CA\_L1S2$$
(In Equation 2, CA_L6S1 means a size of a maximum clear aperture (clear aperture; CA) on the object side of the sixth lens, CA_L1S1 means a size of a maximum clear aperture on the object side of the first lens, CA_L1S2 means a size of a maximum clear aperture on the image side of the first lens);
$$CA\_L6S2 > CA\_L1S1 , \qquad [ Equation 3 ]$$
$$CA\_L6S2 > CA\_L1S2$$
(In Equation 3, CA_L6S2 means a size of a maximum clear aperture on the image side of the sixth lens, CA_L1S1 means the size of the maximum clear aperture on the object side of the first lens, CA_L1S2 means the size of the maximum clear aperture on the image side of the first lens).

16. The optical module according to claim 9, wherein the optical module satisfies Equation 5 below:
$$0.6 < \vert EFL\_ 2 / f 6 \vert / \vert EFL\_ 1 / f 6 \vert < 0.7 \qquad [ Equation 5 ]$$
(In Equation 5, EFL_1 is an effective focal length at a maximum moving distance of the second lens group in first mode, EFL_2 is an effective focal length at a maximum moving distance of the second lens group in second mode, and f6 is a focal length of the sixth lens.)

17. The optical module according to claim 9, wherein the optical module satisfies Equation 6 below:
$$1. < \vert EFL\_ 2 / f34\_ 2 \vert / \vert EFL\_ 1 / f34\_ 1 \vert < 2.5 \qquad [ Equation 6 ]$$
(In Equation 6, EFL_1 is an effective focal length at a maximum moving distance of the second lens group in first mode, EFL_2 is an effective focal length at a maximum moving distance of the second lens group in second mode, f34_1 is a complex focal length of the third lens and the fourth lens at the maximum moving distance of the second lens group in first mode, f34_2 means a combined focal length of the third lens and fourth lens at the maximum moving distance of the second lens group in second mode).

18. The optical module according to claim 9, wherein the optical module satisfies Equation 7 below:
$$0.6 < \vert EFL\_ 2 / f56\_ 2 \vert / \vert EFL\_ 1 / f56\_ 1 \vert < 0.7 \qquad [ Equation 7 ]$$
(In Equation 7, EFL_1 is an effective focal length at a maximum moving distance of the second lens group in first mode, EFL_2 is an effective focal length at a maximum moving distance of the second lens group in second mode, f56_1 is a complex focal length of the fifth lens and the sixth lens at the maximum moving distance of the second lens group in first mode, f56_2 means a complex focal length of the fifth lens and the sixth lens at the maximum moving distance of the second lens group in second mode).

19. The optical module according to claim 9, wherein the optical module satisfies Equation 22 below:
$$8 < TTL / md 1 < 12 \qquad [ Equation 22 ]$$
(In Equation 22, md1 means a moving distance of the second lens group G2 when changing from infinity mode (first mode) to short-distance mode (second mode) or from short-distance mode (second mode) to infinity mode (first mode), Total track length (TTL) refers to a distance in a direction of the optical axis OA from a vertex of the object side of the lens closest to an object among a plurality of lenses to an image surface of an image sensor unit).

20. A camera module comprising:
an optical system;
an image sensor unit where light passing through the optical system is incident; and
a driving member that drives the optical system,
wherein the optical system comprises a first lens group, a second lens group, and a third lens group, which are sequentially arranged along an optical axis from an object side to an image side and each lens group includes at least one lens;
wherein the refractive power sign of the first lens group and the refractive power sign of the second lens group are opposite to each other,
wherein the driving member controls a position of the second lens group, and
wherein the first lens group, the second lens group, and the third lens group satisfy Equation 4 below:
$$0 < \vert P 6 \vert < \vert P 1 \vert , \vert P 2 \vert , \vert P 3 \vert , \vert P 4 \vert , \vert P 5 \vert \qquad [ Equation 4 ]$$
(In Equation 4, P1, P2, P3, P4, P5, and P6 refer to refractive power of a first lens, second lens, third lens, fourth lens, fifth lens, and sixth lens, respectively).
